(19) United States
(12) Patent Application Publication
(10) Pub. No.: US 2026/0218557 A1
(43) Pub. Date: Jul. 30, 2026

(54) IMPROVEMENTS IN POCKET DOOR SUSPENSION SYSTEMS

(71) Applicant: Accuride International Ltd., Northampton (GB)

(72) Inventor: Stefan HERCHENREDER, Cambridgeshire (GB)

(21) Appl. No.: 19/107,955

(22) PCT Filed: Sep. 8, 2023
(86) PCT No.: PCT/GB2023/052321

§ 371 Date: Feb. 28, 2025

(30) Foreign Application Priority Data
Sep. 8, 2022 (GB) 202213135

(51) Int. Cl. E05D 15/58

(52) U.S. Cl. CPC E05D 15/581; E05D 2015/586; E05Y 2201/64; E05Y 2201/684; E05Y 2900/212

(57) ABSTRACT

A suspension system for pocket doors includes a pair of re-circulating ball sliding support assemblies, a pair of hinges, and a synchronising mechanism for synchronising movement of the pocket door relative to the pair of re-circulating ball sliding support assemblies. There is also provided a system including a pair of ball sliding support assemblies, a pair of hinges, a synchronising mechanism for synchronising movement of the pocket door relative to the sliding support assemblies, and a mechanism for aligning the sliding support assemblies relative to one another when setting up the synchronising mechanism. There is also provided a sliding support assembly which is resistant to being pulled apart by lateral loads. There is also provided an elongate rail for a sliding support assembly which can be adjusted in length without affecting the ease of mounting another component to the end of the rail.

### FIELD OF THE INVENTION

The present invention relates to suspension systems for pocket doors, in particular suspension systems for doors that are movable between a first position and a third position, via a second position. In the first position, the door covers an opening defined in a first plane. In the second position, the door has been rotated and extends away from the opening in a direction perpendicular to the first plane on a first side of the first plane. In the third position, the door still extends in a direction perpendicular to the first plane but has been translated in a direction perpendicular to the first plane so that it is now positioned on a second side of the first plane which is opposite to the first side. In the third position, the door can be stowed adjacent to a wall that is perpendicular to the first plane, preferably with a front edge of the door lying adjacent to the end of the wall. The door can be stowed so that it either overlays the wall, or it is positioned within a cavity defined in the wall.

### BACKGROUND TO THE INVENTION

Pocket doors are well known. They can be used in rooms which have limited space so that a door can be opened and then stowed in a position which overlies a wall. The door can sometimes be stowed in a cavity in a wall of a room. Pocket doors are also used on cabinets, for example on television cabinets or kitchen cabinets so that a door can be opened and then moved out of the room and into a pocket within the cabinet. Pocket doors can also be used on kitchen appliances such as ovens where the oven door is opened and then stowed in a cavity beside or beneath the oven. Thus, pocket doors are known that are hinged along a vertical side edge, and are also known that are hinged along a horizontal bottom edge.

Many pocket door suspension systems are known. For example, US 4,974,912 discloses a suspension system for a pocket door that includes at least two telescoping slide assemblies, one portion of each slide assembly is attached to a supporting wall that is perpendicular to a first plane defined by an opening. The slide assemblies are spaced relative to one another and are fixed to the supporting wall so that they are substantially parallel to one another and lie substantially in the same plane. The door is attached to the slide assemblies by hinges, one leaf of each hinge being attached to a pivoting edge of the door, and the other leaf of each hinge being attached to the movable, telescoping portion of the slide assembly to allow the door to pivot between a position perpendicular to the slide assemblies and a position parallel to the slide assemblies. The door is held square to the slides and supporting wall by employing cable elements. One end of each cable element is fixed adjacent to the rear end of the fixed portion of one slide assembly, the other end of each cable element is fixed adjacent the front end of the fixed portion of the other slide assembly. Each cable element is trained around a pair of pullies, one of the pair of pullies being attached to a respective one of the movable, telescopic portions of the slide assemblies. Thus, as the door moves between its open and retracted positions, the cable elements cooperate with the pullies on the movable portions of the slide assemblies, to hold the movable portions of the slide assemblies in a fixed, square relationship to one another, thus preventing skewing caused by the force of gravity on the door, or any vertical forces applied to the door by the user. A series of bearing balls is positioned in upper and lower channels of the fixed portion of the slide assemblies. The fixed portion of the slide assemblies comprises an elongate rail. The bearing balls are held in the channels by ball retainers. The movable, telescoping portions of the slide assemblies roll along the bearing balls.

Since the channel portions of the fixed portions of the slide assemblies include bearing balls along their lengths, the slide assemblies must be manufactured with a predetermined length. The length of the slide assemblies is determined by the distance that the door must be translated which, in turn, is related to the overall width of the door. It is not possible for an end user to alter the length of the slide assemblies or suspension system for use with doors of different widths because the ball retainers are sized and shaped for the particular length of the upper and lower channels, and neither the ball retainers nor channels are readily adjustable. Instead, an end user must have a different suspension system for each door width that they wish to manufacture or install.

There is a need for a suspension system for a pocket door that can be easily adjusted or modified so that it can be used with doors of different widths. The present invention addresses this need.

There is also a need for a suspension system for a pocket door that can be set up easily so that the sliding support assemblies are synchronised and aligned with one another.

There is also a need for a sliding support assembly that is capable of withstanding a heavy lateral load since heavy loads are known to pull movable, telescoping portions of slide assemblies away from and out of their elongate rails.

There is also a need for a quick and easy way of affixing components, such as synchronising mechanisms or other components, to the ends of elongate rails.

### SUMMARY OF THE INVENTION

In a first embodiment, the present invention provides a suspension system for a door, the suspension system comprising:
a first re-circulating ball sliding support assembly, comprising:
   a first elongate rail of channel section defining a first web and first and second flanges, the first elongate rail having a first end and a second end;
   a first slide cassette positioned between the first and second flanges such that the first slide cassette and the first and second flanges define at least one first endless track; and
   a first plurality of bearing balls positioned within the first and second endless tracks;
a second re-circulating ball sliding support assembly, comprising:
   a second elongate rail of channel section defining a second web and third and fourth flanges, the second elongate rail having a first end and a second end;
   a second slide cassette positioned between the third and fourth flanges such that the second slide cassette and the third and fourth flanges define at least one second endless track; and
   a second plurality of bearing balls positioned within the third and fourth endless tracks;
wherein:
the first and second elongate rails are configured to be mounted on a supporting wall defining a first plane, such that said first and second re-circulating ball sliding support assemblies are spaced apart and parallel to one another, wherein the first end of the first elongate rail is aligned with the first end of the second elongate rail;
a first hinge comprising first and second leaves, wherein the first leaf is connected to the first slide cassette and the second leaf is configured to be connected to the door;
a second hinge comprising third and fourth leaves, wherein the third leaf is connected to the second slide cassette and the fourth leaf is configured to be connected to the door; and
a synchronising mechanism configured to maintain the positions of the first and second slide cassettes within the respective first and second elongate rails such that a distance between the first slide cassette and the first end of the first elongate rail is always the same as a distance between the second slide cassette and the first end of the second elongate rail.

The at least one first endless track may comprise a single track in, for example, a figure of eight configuration. Alternatively, the at least one first endless track may comprise a first endless track and a third endless track. The at least one second endless track may comprise a single track in, for example, a figure of eight configuration. Alternatively, the at least one second endless track may comprise a second endless track and a fourth endless track.

In addition, the second end of the first elongate rail may be aligned with the second end of the second elongate rail.

The suspension system of the present invention uses two re-circulating ball sliding support assemblies. The bearing balls are contained within the endless tracks defined by the slide cassettes and the respective flanges. Therefore, the elongate rails can be cut to their desired length without having to modify the slide cassette or the bearing balls. Consequently, the suspension system of the present invention can be easily modified so that it can be used for doors of various different widths, merely by cutting the extruded elongate rails to their required size.

Re-circulating ball sliding support assemblies are known. For example, see EP 3 143 298 A1. However, prior to the present invention, re-circulating ball sliding support assemblies have not been used in a suspension system for a pocket door.

The suspension system of the present invention can be used to allow a door to move between three positions: a first position in which the door is perpendicular to the supporting wall and covers an opening defined in a first plane, and in which the first leaf of the first hinge is perpendicular to the second leaf and the third leaf of the second hinge is perpendicular to the fourth leaf, i.e. a “closed position”; a second position in which the door has been rotated and the hinges have been opened up so that the first leaf and second leaf are parallel to one another, and the third leaf and fourth leaf are parallel to one another, such that the door extends away from the opening in a direction perpendicular to the first plane and parallel to the supporting wall, i.e. an “open position”; and a third position in which the door has been translated in a direction perpendicular to the first plane and parallel to the supporting wall until it overlies the supporting wall and is stowed adjacent to the supporting wall, i.e. a “stowed position”. In the stowed position a front edge of the door may lie adjacent to the end of the supporting wall.

The first end of the elongate rails may be the end of the elongate rails closest to the door when the door is in its closed position. The second end of the elongate rails may be the end of the elongate rails furthest from the door when the door is in its closed position.

In the closed position and the open position, the slide cassettes are positioned at the first end of their respective elongate rails. In the stowed position, the slide cassettes are positioned close to or at the second end of their respective elongate rails.

The elongate rails preferably comprise extruded rails, more preferably extruded aluminium rails.

Each of the first and second re-circulating ball sliding support assemblies may further comprise a respective first end cap mounted in or on the first end of the respective elongate rail. Each of the first and second re-circulating ball sliding support assemblies may further comprise a respective second end cap mounted in or on the second end of the respective elongate rail. The first and/or second end cap may be formed from a moulded plastics or metal material.

A self-close mechanism may be mounted on the or each first end cap to help to pull the door into its closed position. In addition, or alternatively, a soft-close mechanism may be mounted on the or each first end cap to prevent the slide cassette from slamming into the front end cap when the door is moved from its stowed position to its open position. In addition, or alternatively, a soft-close mechanism may be mounted on the or each second end cap to prevent the door from banging into the back of a cabinet, or to prevent the slide cassette banging into the respective second end cap when the door is moved from its open position to its stowed position. Preferably the system includes a soft-close mechanism on each second end cap and a self-close mechanism on each first end cap.

Each flange of each elongate rail may have a fastener receiving channel formed along its length for receiving a fastener for attaching the first and/or second end cap to the first or second end of the respective elongate rail. Each elongate rail may be extruded to have a constant cross-section along its entire length. Consequently, the or each end cap can easily be attached to one of the ends of the elongate rails, even if the elongate rails are cut down to reduce their length. The fastener receiving channel may open onto an outer edge of the respective flange. Alternatively, the fastener receiving channel may be enclosed within the cross-section of the flange such that the cross-section of the flange has a hole therein.

Forming a fastener receiving channel along the length of a flange is also advantageous and applicable to other applications where it may be desirable to fit an end cap or other component to the end of a channel that can be cut to length.

Therefore, in a second embodiment, there is provided an elongate rail for a sliding support assembly, the elongate rail being of channel section and having a first end and a second end, the elongate rail comprising:
a first web; and
first and second flanges, wherein
the first flange defines a first channel for supporting a plurality of bearing balls, and the second flange defines a second channel for supporting a plurality of bearing balls, wherein
a first fastener receiving channel separate from the first channel is formed along the length of the first flange, and
a second fastener receiving channel separate from the second channel is formed along the length of the second flange, wherein
   the first and second fastener receiving channels are for receiving a fastener for attaching an end cap to the elongate rail.

Other features of the suspension system of the first embodiment can be used with the elongate rail of the second embodiment.

Each fastener receiving channel may open onto an outer edge of the respective flange. Alternatively, each fastener receiving channel may be enclosed within the cross-section of the flange such that the cross-section of the flange has a hole therein. The elongate rail may be extruded such that it has a constant cross-section along its entire length. An end cap may be mounted in or on an end of the elongate rail using a fastener.

In both the first and second embodiments, the or each end cap may have first and second fastener receiving holes formed therein which are spaced apart a distance equal to the distance between the fastener receiving channels formed in the flanges of the respective elongate rail. Accordingly, a pair of fasteners such as screws, or rivets, can be used to connect the or each end cap to the respective end of the respective elongate rail. For example, a screw can be passed through each of the fastener receiving holes and then screwed into the respective fastener receiving channel in the elongate rail. The size of the screw can be selected so that it will self-tap into the material from which the elongate rail is formed. Alternatively, each end cap can include a pair of protrusions which fit into the respective fastener receiving channels. The screw can then fit into the protrusion to expand the protrusion such that it frictionally engages the respective fastener receiving channel and holds the end cap in place. The protrusions can be moulded or otherwise formed as part of the end cap

In the first embodiment, the first sliding support assembly may be positioned vertically above the second sliding support assembly, such that the first hinge can be connected to an upper portion of the door, and the second hinge can be connected to a lower portion of the door. The first and second sliding support assemblies may comprise a mirrored pair, i.e. they may have mirror symmetry about a plane which is positioned halfway between the first sliding support assembly and the second sliding support assembly.

In the first embodiment, the first slide cassette may include a first bracket extending in a direction towards the second slide cassette. The second slide cassette may include a second bracket extending in a direction towards the first slide cassette. Accordingly, the first bracket may extend downwards from the first slide cassette, and the second bracket may extend upwards from the second slide cassette. The first leaf of the first hinge may be mounted on the first bracket. The third leaf of the second hinge may be mounted on the second bracket. The first and/or second brackets may be formed in any appropriate way, for example they may be formed from a metal material, such as aluminium or steel or moulded from a plastics material or polymer.

The first bracket may be connected to the second bracket via a hinge carrier bar. The first leaf of the first hinge and the third leaf of the second hinge may be mounted on the hinge carrier bar. Alternatively, the first leaf of the first hinge may be mounted on the first bracket, and the third leaf of the second hinge may be mounted on the second bracket. The system may further comprise at least one third hinge comprising fifth and sixth leaves, wherein the fifth leaf is connected to the hinge carrier bar and the sixth leaf is configured to be connected to the door. A plurality of such third hinges can be connected to the hinge carrier bar via their fifth leaves to increase the number of connections between the door and the suspension system. Increasing the number of hinges connecting the door to the suspension system prevents the door from flexing or wobbling in use. The hinge carrier bar may comprise an extruded hinge carrier bar. The extruded hinge carrier bar may comprise an aluminium extruded hinge carrier bar.

Alternatively, the first bracket may have a first hinge bracket mounted thereto and extending in the direction towards the second bracket. The second bracket may have a second hinge bracket mounted thereto and extending in the direction towards the first bracket. The system may further comprise a third hinge comprising fifth and sixth leaves, wherein the fifth leaf is connected to the first hinge bracket and the sixth leaf is configured to be connected to the door. The system may further comprise a fourth hinge comprising seventh and eighth leaves, wherein the seventh leaf is connected to the second hinge bracket and the eighth leaf is configured to be connected to the door. In this configuration, the number of hinges close to the top and bottom of the door can be increased, without having to add a hinge carrier bar, thus providing a cheaper way of increasing the number of hinges without the additional expense of a hinge carrier bar.

In the first embodiment, the synchronising mechanism may comprise a cable synchronising mechanism. In particular, the first slide cassette may have a first pulley wheel mounted thereon, and the second slide cassette may have a second pulley wheel mounted thereon. When the first slide cassette includes a first bracket, the first pulley wheel may be mounted on the first bracket. When the second slide cassette includes a second bracket, the second pulley wheel may be mounted on the second bracket.

The cable synchronising mechanism may include a first cable and a second cable. A first end of the first cable may be connected to the first end of the first elongate rail, and the first cable may run parallel to the first elongate rail, around the first pulley wheel and towards the second elongate rail, around the second pulley wheel, and then parallel to the second elongate rail. A second end of the first cable may be connected to the second end of the second elongate rail. A first end of the second cable may be connected to the first end of the second elongate rail, and the second cable may run parallel to the second elongate rail, around the second pulley wheel and towards the first elongate rail, around the first pulley wheel, and then parallel to the first elongate rail. A second end of the second cable may be connected to the second end of the first elongate rail. The cables may be connected to the respective ends of the elongate rails via a connection between the cable and the respective end cap. The connection between each cable and the respective end cap may be adjustable to provide for adjustment of the synchronisation. In particular, each cable may be connected to a respective end cap via a threaded tensioning mechanism. Other cable synchronising mechanisms are known and can be used with the system of the present invention, such as those disclosed in U.S. Pat. No. 4,974,912. Alternatively, the synchronising mechanism may comprise a rack and pinion synchronising mechanism.

Each of the first and second pulley wheels may include a guide surface in which the first and second cables can run. Alternatively, each of the first and second pulley wheels can include a pair of guide surfaces where the first cable runs in the first guide surface and the second cable runs in the second guide surface. Each guide surface may be moulded into the respective pulley wheel, or formed by cutting a channel into a cylindrical surface of the respective pulley wheel, or by forming the respective pulley wheel from a stack of different diameter discs. The cross-section of the channel may be semi-circular or v-shaped, for example.

The first and second pulley wheels may be mounted on the respective first and second slide cassettes via first and second bearings. The first and second bearings allow a higher tension to be applied to the cables which improves the synchronisation and ensures a smoother movement of the door and slide cassettes along the elongate rails. The first and second bearings also increase the durability of the synchronisation mechanism and system.

The synchronising mechanism functions to ensure that any movement of the first slide cassette along the first elongate rail is synchronised with any movement of the second slide cassette along the second elongate rail. That is, the distance between the first end of the first elongate rail and the first slide cassette is the same as the distance between the first end of the second elongate rail and the second slide cassette. The synchronising mechanism prevents the door from being skewed or sagging, and the slide cassettes from becoming jammed in their elongate rails when the door is slid from its open position to its stowed position.

In order to set the sequencing of the two sliding support assemblies, i.e. in order to align the first slide cassette and the second slide cassette during initial setup of the suspension system, a means for holding the first and second cassettes in a known, aligned position within their respective elongate rail may be provided so that the cables of the synchronising mechanism can be fitted to the system easily and connected to the first and second ends of the elongate rails without introducing any misalignment of the sliding support assemblies.

The means for holding the first and second cassettes in a known, aligned position is also applicable to suspension systems which use telescoping slides that do not use recirculating ball sliding support assemblies. In particular, the means for holding the first and second cassettes can be used with suspension systems that use balls arranged in ball retainers positioned along the length of channels defined by the first and second flanges.

Therefore, in a third embodiment, the present invention also provides a suspension system for a door which comprises:
a first ball sliding support assembly, comprising:
   a first elongate rail of channel section defining a first web and first and second flanges, the first elongate rail having a first end and a second end;
   a first plurality of bearing balls positioned within first channels defined by the first and second flanges; and
   a first slide cassette positioned between the first and second flanges such that the first slide cassette is retained between the first and second flanges and can slide on the first plurality of bearing balls within the first channels;
a second ball sliding support assembly, comprising:
   a second elongate rail of channel section defining a second web and third and fourth flanges, the second elongate rail having a first end and a second end;
   a second plurality of bearing balls positioned within second channels defined by the third and fourth flanges; and
   a second slide cassette positioned between the third and fourth flanges such that the second slide cassette is retained between the third and fourth flanges and can slide on the second plurality of bearing balls within the second channels; wherein:
the first and second elongate rails are configured to be mounted on a supporting wall defining a first plane, such that said first and second ball sliding support assemblies are spaced apart and parallel to one another, wherein the first ends of the first and second elongate rails are aligned with one another;
a first hinge comprising first and second leaves, wherein the first leaf is connected to the first slide cassette and the second leaf is configured to be connected to the door;
a second hinge comprising third and fourth leaves, wherein the third leaf is connected to the second slide cassette and the fourth leaf is configured to be connected to the door;
a synchronising mechanism configured to maintain the positions of the first and second slide cassettes within the respective first and second elongate rails such that a distance between the first slide cassette and the first end of the first elongate rail is always the same as a distance between the second slide cassette and the first end of the second elongate rail; and
a means for holding the first and second cassettes in a known, aligned position within their respective elongate rail.

In addition, the second ends of the first and second elongate rails may be aligned with one another. Other features of the suspension system of the first embodiment and the elongate rail of the second embodiment are also equally applicable to the third embodiment.

In both the first and third embodiments, the means for holding the first and second cassettes may comprise a pair of holes formed in the web of each elongate rail. The pair of holes comprises a first hole and a second hole. The distance between the first hole and the second hole corresponds to a length of the slide cassette measured in the direction parallel to the length of the respective elongate rail. The distance between the first hole in the first elongate rail and the first end of the first elongate rail is the same as the distance between the first hole in the second elongate rail and the first end of the second elongate rail. The distance between the second hole in the first elongate rail and the first end of the elongate rail is the same as the distance between the second hole in the second elongate rail and the first end of the second elongate rail. Accordingly, during initial set up, a fastener or stop can be placed in each of the first and second holes to hold the first and second slide cassettes in a known, aligned position within their respective elongate rail. The cables of the synchronising mechanism can then be fitted to the system and connected to the first and second ends of the elongate rails. Once the cables have been fitted and connected, the fasteners or stops can be removed entirely from each of the first and second holes. The first and second holes may extend partially or all the way through the respective web of the elongate rail. This arrangement provides a simple and reliable way of setting the synchronisation between the two sliding support assemblies.

Alternatively, the means for holding the first and second cassettes may comprise a first hole in the first slide cassette, a corresponding second hole in the second slide cassette, a third hole in the first web of the first elongate rail, and a fourth hole in the second web of the second elongate rail. The distance between the third hole and the first end of the first elongate rail is the same as the distance between the fourth hole and the first end of the second elongate rail. The first hole in the first slide cassette is positioned a first distance from a first end of the first slide cassette. The second hole in the second slide cassette is positioned the same first distance from a first end of the second slide cassette. Accordingly, during initial set up, a first fastener or stop can be placed in the first and third holes, and a second fastener or stop can be placed in the second and fourth holes to hold the first and second slide cassettes in a known, aligned position within their respective elongate rail. The cables of the synchronising mechanism can then be fitted to the system and connected to the first and second ends of the elongate rails. Once the cables have been fitted and connected, the fasteners or stops can be removed from each of the third and fourth holes. The fasteners or stops can then be left in place in the first and second holes, or removed from the cassettes entirely. The third and fourth holes may extend partially or all the way through the respective web of the elongate rail. This arrangement provides another simple and reliable way of setting the synchronisation between the two sliding support assemblies.

In both the first and third embodiments, the elongate rails may also include mounting holes, each mounting hole positioned for receiving a fastener such as a screw for connecting the elongate rail to the supporting wall.

In both the first and third embodiments, the first and second slide cassettes may each include a detent mechanism which can interact with a receiving mechanism on the first end cap in order to resist motion of the first and second slide cassettes relative to the respective first end cap. The detent mechanism may comprise a tab extending from the respective slide cassette in a direction parallel to the length of the elongate rail. The receiving mechanism may comprise a roller mounted on the first end cap. The tab may be shaped to catch around the roller in order to increase the force required to start motion of the first and second slide cassettes along their respective elongate rail. In particular, the tab may have a curved portion shaped to curve around the outer cylindrical surface of the roller. The tab of the detent mechanism may extend from, and be formed as part of, the bracket mounted on the slide cassette, such as the first and second bracket mentioned above. Alternatively, the detent mechanism may comprise a separate detent bar connected to the slide cassette and/or the first or second bracket. The tab or detent bar may be formed from a metal or plastics material or any other suitable material. The roller may be formed from a metal or plastics material or any other suitable material.

In both the first and third embodiments, a spacer roller may be mounted on the first end cap whether or not the first and second slide cassettes include a detent mechanism. If a detent mechanism is present, the spacer roller may comprise the same roller as the roller of the receiving mechanism for the detent mechanism. Alternatively, the spacer roller may comprise an additional roller to the roller of the receiving mechanism for the detent mechanism. The spacer roller may extend away from the elongate rail in a direction perpendicular to the web of the elongate rail. The spacer roller may extend in that direction further than other parts of the first end cap and further than the flanges of the elongate rail, so that, as the door is moved from its open position to its stowed position, the front surface of the door is held away from the first cap and the elongate rail and prevented from being scratched. The spacer roller may be formed from a plastics material and may have rubberised o-rings mounted around the cylindrical surface of the spacer roller to absorb any vibrations and prevent marking of the front surface of the door with prolonged use. Instead of rubberised o-rings, the spacer roller may be moulded or otherwise formed with one or more ridges to absorb any vibrations and prevent marking of the front surface of the door. The spacer roller may be moulded or otherwise formed from a single material or from two different materials such that the ridges may be formed from the same or a different material from the body of the spacer roller.

When the door is moved from the open position to the closed position, the weight of the door acts to pull the ball slide cassette out of the channel section of the elongate rail, in a direction perpendicular to the web of the elongate rail. In order to prevent the weight of the door pulling the sliding support assemblies apart, and thus to allow the suspension systems of the first or second embodiment to be used with much larger and heavier doors, the first and/or second sliding support assembly may include a catch mechanism which prevents movement of the slide cassette out of the channel section of the elongate rail in a direction perpendicular to the web of the elongate rail.

The catch mechanism described above is also advantageous and applicable to sliding support assemblies used for other applications, where a heavy load may apply lateral forces to the slide cassette such that the slide cassette is pulled away from the web of the elongate rail.

Therefore, in a fourth embodiment, there is provided a sliding support assembly comprising:
an elongate rail of channel section defining a first web and first and second flanges, the elongate rail having a first end and a second end;
a plurality of bearing balls positioned within first channels defined by the first and second flanges;
a slide cassette positioned between the first and second flanges such that the first slide cassette is retained between the first and second flanges and can slide on the first plurality of bearing balls within the first channels; and
a catch mechanism which prevents movement of the slide cassette out of the channel section of the respective elongate rail in a direction perpendicular to the web of the elongate rail.

A first end cap may be mounted in or on the first end of the elongate rail.

Other features of the sliding support assemblies, elongate rails and end caps of the first, second and third embodiments are also equally applicable to the fourth embodiment.

In all of the first, third and fourth embodiments, the catch mechanism may include an L-shaped catch portion which may be formed on the first and/or second bracket. The L-shaped catch portion has two legs, wherein a first leg extends from the respective first or second bracket in a direction perpendicular to the web of the elongate rail, and the second leg is connected to the first leg and extends in a direction parallel to the web of the elongate rail. The catch mechanism further includes a wall formed in or by the first end cap, which is configured and positioned such that the second leg can be positioned behind the wall to prevent the second leg of the catch portion moving in a direction perpendicular to the web of the elongate rail. The wall extends in a direction parallel to the web of the elongate rail. When the second leg is positioned behind the wall, the wall prevents the catch portion from moving in a direction perpendicular to the web of the elongate rail. Consequently, the catch mechanism prevents the weight of the door pulling the slide cassette out of the channel section of the elongate rail and away from the web of the elongate rail.

In both of the first and third embodiments, the suspension system may further comprise a third re-circulating ball sliding support assembly, comprising: a third elongate rail of channel section defining a third web and fifth and sixth flanges, the third elongate rail having a first end and a second end; a third slide cassette positioned between the fifth and sixth flanges such that the third slide cassette and the fifth and sixth flanges define at least one fifth endless track; and a third plurality of bearing balls positioned within the at least one fifth endless track. The third elongate rail is configured to be mounted on the wall between the first elongate rail and the second elongate rail, such that the first, second and third re-circulating ball sliding support assemblies are spaced apart and parallel to one another, wherein the first ends of the first, second and third elongate rails are aligned with one another. The system may further comprise at least one third hinge comprising fifth and sixth leaves, wherein the fifth leaf is connected to the third slide cassette and the sixth leaf is configured to be connected to the door. The system may comprise a pair of third hinges, wherein each of the fifth leaves is connected to the third slide cassette and each of the sixth leaves is configured to be connected to the door.

In addition, the second ends of the first, second and third elongate rails may be aligned with one another.

The at least one fifth endless track may comprise a single track in, for example, a figure of eight configuration. Alternatively, the at least one fifth endless track may comprise a fifth endless track and a sixth endless track.

Incorporation of the third sliding assembly provides for increased loading capability so that the suspension system can be used with larger and heavier doors.

The third slide cassette may be connected to the first slide cassette via a first bar. The first bar may comprise a hinge carrier bar onto which additional third hinges can be mounted. The third slide cassette may be connected to the second slide cassette via a second bar. The second bar may comprise a hinge carrier bar onto which additional third hinges can be mounted.

The third slide cassette may include a third bracket extending from both sides of the third slide cassette towards both the first slide cassette and the second slide cassette. Accordingly, the third bracket may extend upwards towards the first slide cassette and downwards towards the second slide cassette. The fifth leaf of a third hinge may be mounted on the part of the third bracket that extends towards the first slide cassette. The fifth leaf of another third hinge may be mounted on the part of the third bracket that extends towards the second slide cassette.

Prior to the present invention, it has not been possible to add a third, central sliding assembly to a suspension system for a pocket door because the third slide mechanism gets in the way of the synchronising mechanism. The present invention addresses this problem.

In particular, in a fifth embodiment, the present invention provides a suspension system for a door, the suspension system comprising:
a first ball sliding support assembly, comprising:
   a first elongate rail of channel section defining a first web and first and second flanges, the first elongate rail having a first end and a second end;
   a first plurality of bearing balls positioned within first channels defined by the first and second flanges; and
   a first slide cassette positioned between the first and second flanges such that the first slide cassette is retained between the first and second flanges and can slide on the first plurality of bearing balls within the first channels;
a second ball sliding support assembly, comprising:
   a second elongate rail of channel section defining a second web and third and fourth flanges, the second elongate rail having a first end and a second end;
   a second plurality of bearing balls positioned within second channels defined by the third and fourth flanges; and
   a second slide cassette positioned between the third and fourth flanges such that the second slide cassette is retained between the third and fourth flanges and can slide on the second plurality of bearing balls within the second channels; and
a third ball sliding support assembly, comprising:
   a third elongate rail of channel section defining a third web and fifth and sixth flanges, the third elongate rail having a first end and a second end;
   a third plurality of bearing balls positioned within second channels defined by the fifth and sixth flanges; and
   a third slide cassette positioned between the fifth and sixth flanges such that the third slide cassette is retained between the fifth and sixth flanges and can slide on the third plurality of bearing balls within the third channels;
   wherein:
the first, second and third elongate rails are configured to be mounted on a supporting wall defining a first plane, and the third elongate rail is configured to be mounted on the supporting wall between the first and second elongate rails, such that said first, second and third ball sliding support assemblies are spaced apart and parallel to one another, wherein the first ends of the first, second and third elongate rails are aligned with one another;
a first hinge comprising first and second leaves, wherein the first leaf is connected to the first slide cassette and the second leaf is configured to be connected to the door;
a second hinge comprising third and fourth leaves, wherein the third leaf is connected to the second slide cassette and the fourth leaf is configured to be connected to the door;
at least one third hinge comprising fifth and sixth leaves, wherein the fifth leaf is connected to the third slide cassette and the sixth leaf is configured to be connected to the door;
a cable synchronising mechanism configured to maintain the positions of the first and second slide cassettes within the respective first and second elongate rails such that a distance between the first slide cassette and the first end of the first elongate rail is always the same as a distance between the second slide cassette and the first end of the second elongate rail; and
a guide member mounted on the third slide cassette, wherein the guide member defines a channel through which one or more cables of the cable synchronising mechanism can pass.

In addition, the second ends of the first, second and third elongate rails may be aligned with one another.

Other features of the first, second, third and fourth embodiments are also equally applicable to the fifth embodiment.

The guide member can also be applied to both the first and third embodiments. Therefore, in both the first and third embodiment a guide member may be mounted on the third slide cassette.

In the first, third and fifth embodiments, the guide member defines a channel through which the cables of the synchronising mechanism can pass. The guide member may comprise a channel section moulded or otherwise formed from a plastics or metal material. The guide member may be formed as part of the third bracket. In particular, the guide member may comprise a metal channel, such as steel or aluminium, formed as part of the third bracket.

The first and second pulley wheels may be mounted on the first and second slide cassettes such that the guide surfaces of the pulley wheels are further away from the web of the elongate rails than the flanges of the elongate rails in the direction perpendicular to the web of the elongate rails. As a consequence, the cables can pass through the guide member on the third slide cassette without interfering with the elongate rail of the third recirculating-ball sliding support assembly. The guide member prevents the cables from rubbing on the third elongate rail or third slide cassette during use. However, there is no functional connection between the cables of the synchronisation mechanism and the third sliding support assembly.

### BRIEF DESCRIPTION OF THE DRAWINGS

The following is a brief description of examples of suspension systems, elongate rails and sliding support assemblies according to the invention as shown in the figures, in which:

FIG. 1 shows a front, plan view of a suspension system according to a first example of the present invention;

FIG. 2 shows a front, perspective view of the suspension system of FIG. 1;

FIG. 3 shows a rear view of the suspension system of FIG. 1;

FIG. 4 shows a cross-sectional view through a re-circulating ball sliding support assembly for use in all examples of the invention;

FIG. 5 shows a detailed perspective view of a first end cap of the suspension system of FIG. 1;

FIG. 6 shows a detailed perspective view of a second end cap and portion of an elongate rail and cable of the suspension system of FIG. 1;

FIG. 7 shows an exploded view of the second end cap and portion of the elongate rail and cable of FIG. 6;

FIG. 8 shows an enlarged view of a portion of the suspension system of FIG. 1;

FIG. 9 shows a front, perspective view of a portion of a suspension system according to a second example of the present invention;

FIG. 10 shows a detailed perspective view of a hinge carrier bar and hinge for use in the second example of FIG. 9;

FIG. 11 shows a front, plan view of a portion of a suspension system according to a third example of the present invention;

FIG. 12 shows a rear, perspective view of a portion of the suspension system of FIG. 11;

FIG. 13 shows a rear, perspective view of a portion of the suspension system of FIG. 1;

FIG. 14 shows a side, perspective view of a portion of the suspension system of FIG. 1;

FIG. 15a shows a front, perspective view of a mechanism for setting the sequencing of the sliding support assemblies of any of the examples of the present invention that use cable synchronisation;

FIG. 15b shows a front perspective view of an alternative mechanism for setting the sequencing of the sliding support assemblies of any of the examples of the present invention that use cable synchronisation;

FIG. 16a shows an exploded, perspective view of an alternative suspension system with an alternative synchronisation mechanism;

FIG. 16b shows a front view of a portion of the alternative suspension system shown in FIG. 16a;

FIG. 17 shows a front, plan view of a suspension system according to a fourth example of the present invention;

FIG. 18 shows a front, perspective view of a portion of the suspension system of FIG. 17 ;

FIG. 19 shows a front perspective view of a portion of a suspension system according to a fifth example of the present invention;

FIGS. 20a and 20b show plan and perspective views respectively of a door positioned in a first position using a suspension system according to the present invention;

FIGS. 21a and 21b show plan and perspective views respectively of a door positioned in a second position using a suspension system according to the present invention;

FIGS. 22a and 22b show plan and perspective views respectively of a door positioned in a third position using a suspension system according to the present invention;

FIGS. 23a and 23b show plan and perspective views respectively of a soft-close, self-close or self-open mechanism for use with any of the suspension systems of the present invention; and

FIGS. 24a and 24b show plan views of the mechanism of FIGS. 23a and 23b when mounted on one of the elongate rails of any of the suspension systems according to the present invention.

### DETAILED DESCRIPTION OF THE DRAWINGS

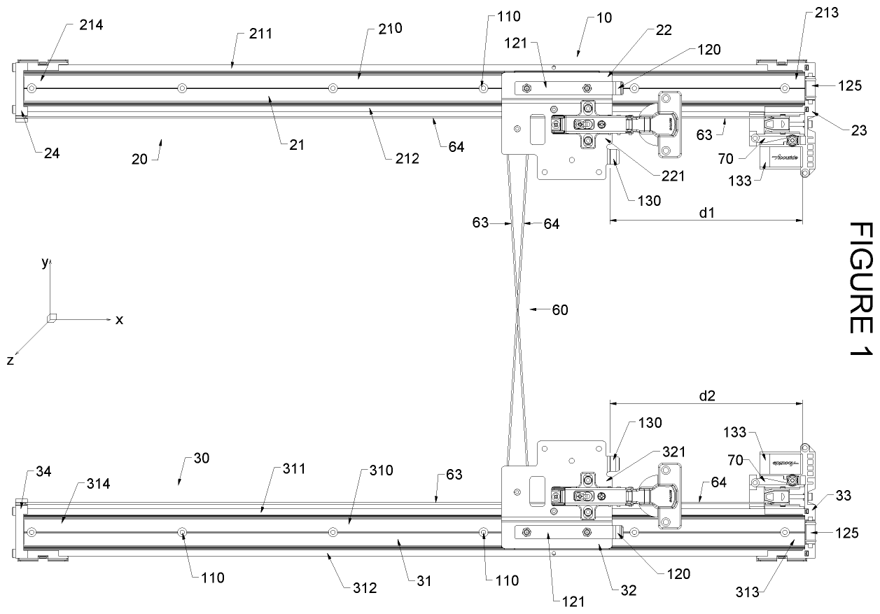

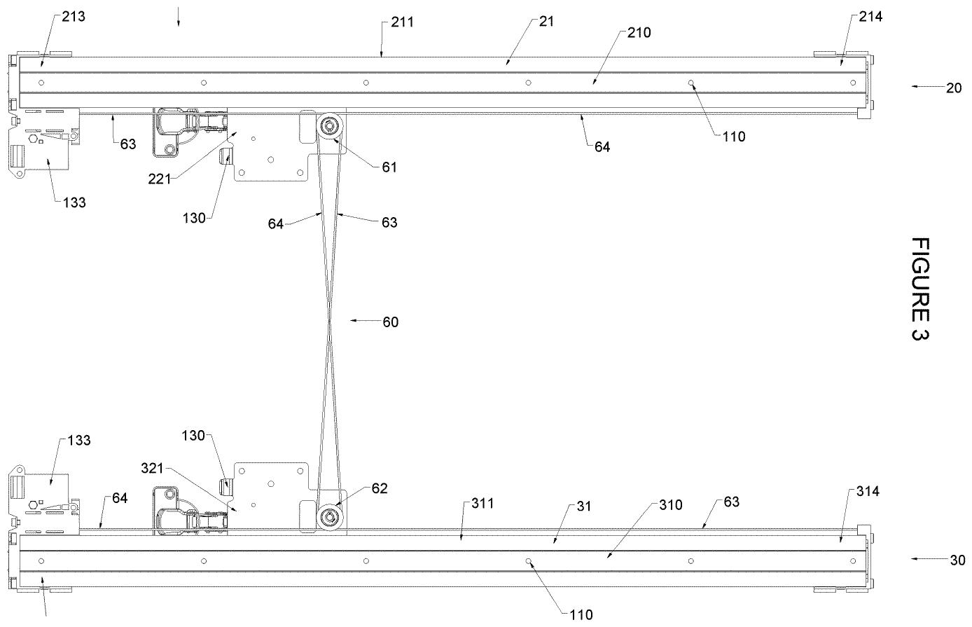

FIGS. 1 to 3 show a suspension system 10 for a door, according to a first example of the invention. The suspension system 10 includes a first re-circulating ball sliding support assembly 20. The first re-circulating ball sliding support assembly 20 comprises a first elongate rail 21 of channel section defining a first web 210 and first and second flanges 211, 212. The first elongate rail 21 has a first end 213 and a second end 214.

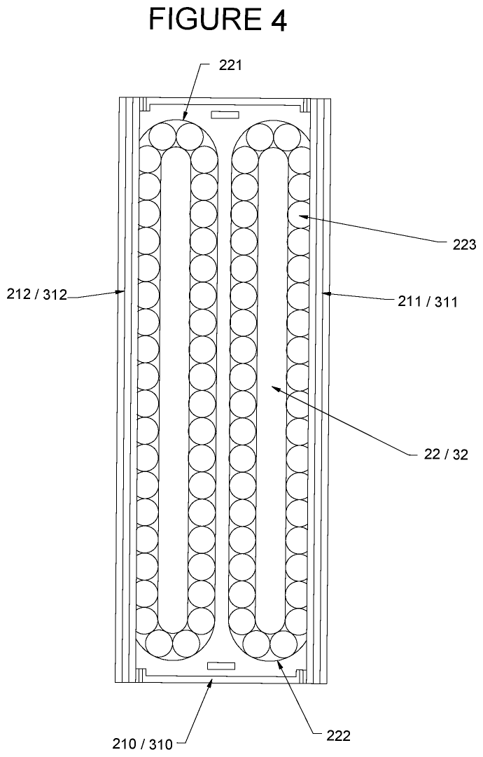

A first slide cassette 22 is positioned between the first and second flanges 211, 212. As can be seen from FIG. 4, the first slide cassette comprises a body with a cross-section that is configured such that the first slide cassette 22 and the first and second flanges 211, 212 define a first endless track 221 and a second endless track 222. A first plurality of bearing balls 223 are positioned within the first and second endless tracks 221, 222. Alternatively, the body of the first slide cassette may have a cross-section that is configured such that the first slide cassette and the first and second flanges define a single endless track in a figure of eight configuration.

The suspension system 10 also includes a second re-circulating ball sliding support assembly 30. The second re-circulating ball sliding support assembly 30 comprises a second elongate rail 31 of channel section defining a second web 310 and third and fourth flanges 311, 312. The second elongate rail 31 has a first end 313 and a second end 314.

A second slide cassette 32 is positioned between the third and fourth flanges 311, 312. The second slide cassette 32 is the same as the first slide cassette 22 a shown in FIG. 4. Therefore, the second slide cassette 32 and the third and fourth flanges 311, 312 define a third endless track 221 and a fourth endless track 222. A second plurality of bearing balls 223 are positioned within the third and fourth endless tracks 221, 222. Alternatively, the body of the second slide cassette may have a cross-section that is configured such that the second slide cassette and the third and fourth flanges define a single endless track in a figure of eight configuration.

The first and second elongate rails 21, 31 are configured to be mounted on a wall defining a first plane. In FIG. 1, the first plane lines in the plane defined by the axes x and y. As can be seen from FIGS. 1 to 3, the first and second re-circulating ball sliding support assemblies 20, 30 are spaced apart and parallel to one another. In particular, they are spaced apart in the y direction shown in FIG. 1. The first end 213 of the first elongate rail 21 is aligned with the first end 313 of the second elongate rail 31, i.e. they are aligned in the x-direction shown in FIG. 1. The second end 214 of the first elongate rail 21 is aligned with the second end 314 of the second elongate rail 31. i.e. they are aligned in the x-direction shown in FIG. 1. However, it is not always essential for the second ends 214, 314 to be aligned, for example in situations where the cassette comes to a halt before reaching the respective second end of its elongate rail.

The suspension system 10 also includes a first hinge 40 comprising first and second leaves 41, 42, wherein the first leaf 41 is connected to the first slide cassette 22 and the second leaf 42 is configured to be connected to the door (not shown).

The suspension system 10 also includes a second hinge 50 comprising third and fourth leaves 51, 52, wherein the third leaf 51 is connected to the second slide cassette 32 and the fourth leaf 52 is configured to be connected to the door (not shown).

The suspension system 10 also includes a synchronising mechanism 60 configured to maintain the positions of the first and second slide cassettes 22, 32 within the respective first and second elongate rails 21, 31 such that a distance, d1, between the first slide cassette 22 and the first end 213 of the first elongate rail 21 is always the same as a distance, d2 between the second slide cassette 32 and the first end 313 of the second elongate rail 31.

Since the suspension system 10 uses two re-circulating ball sliding support assemblies 20, 30, all of the bearing balls 223 are contained with the endless tracks 221, 222 defined by the slide cassettes 22, 32 and the respective flanges 211, 212; 311, 312. Therefore, the elongate rails 21, 31 can be cut to their desired length from either their first end 213, 313 or their second end 214, 314 without having to modify the slide cassettes 22, 32 or the bearing balls 223. Consequently, the suspension system 10 can be easily modified so that it can be used for doors of various different widths, merely by cutting the extruded elongate rails 21, 31 to their required length.

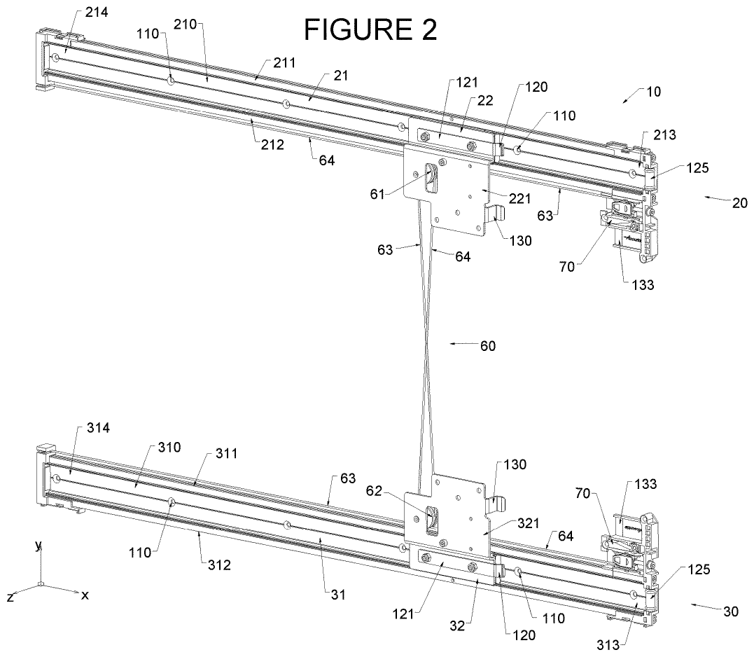

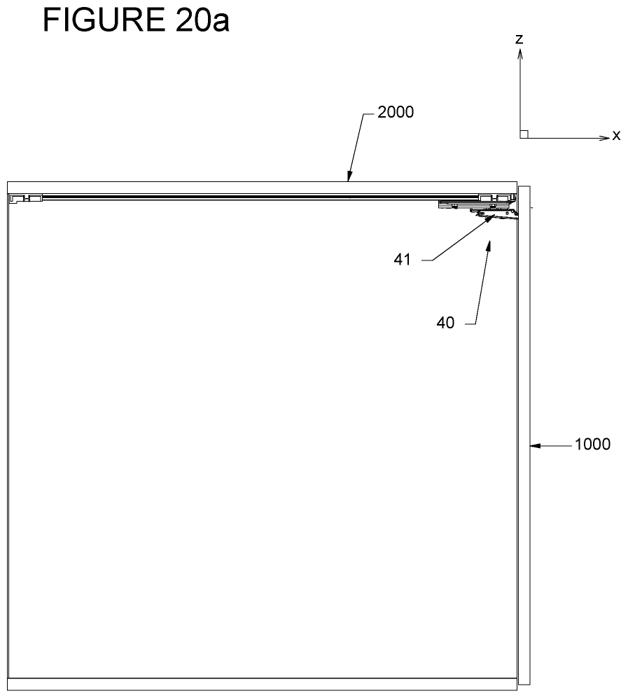

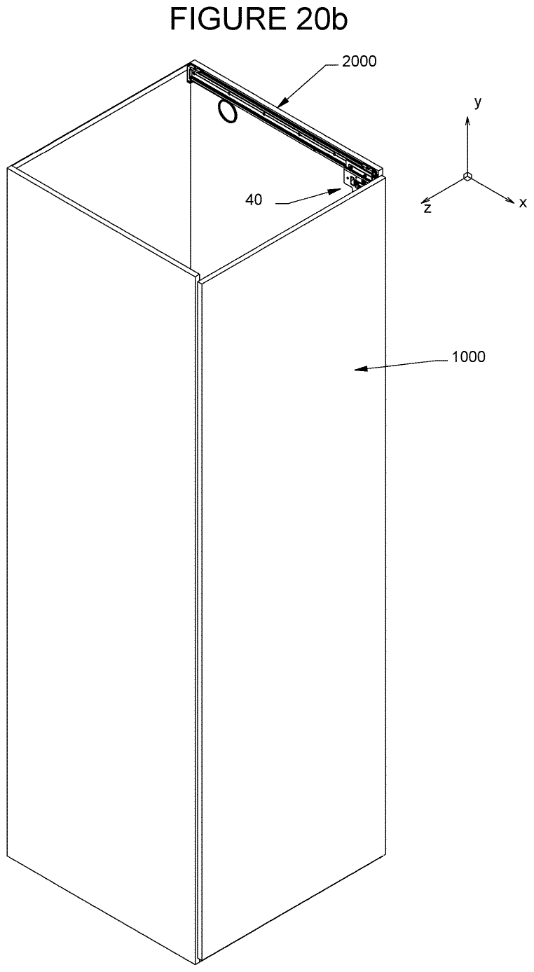

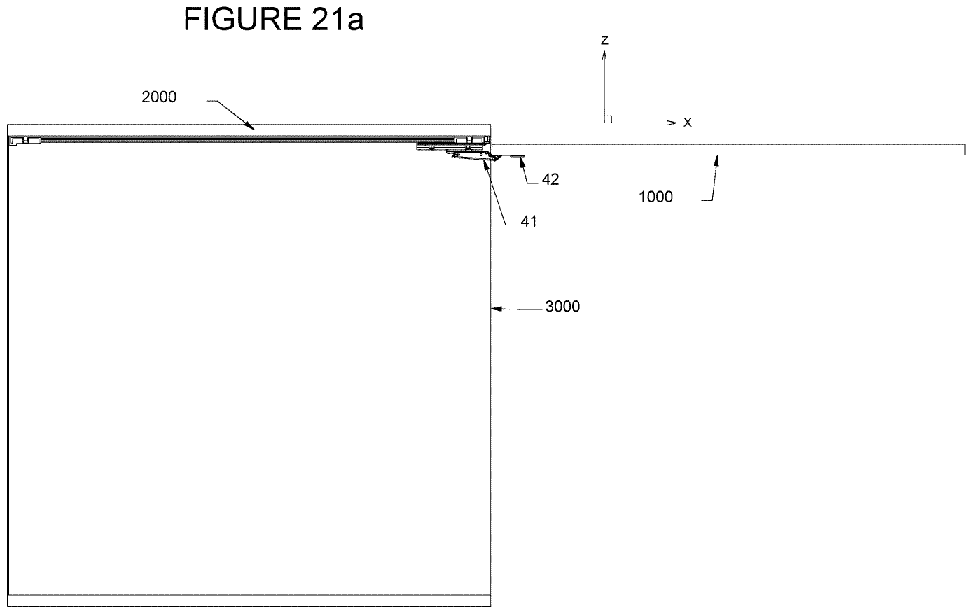

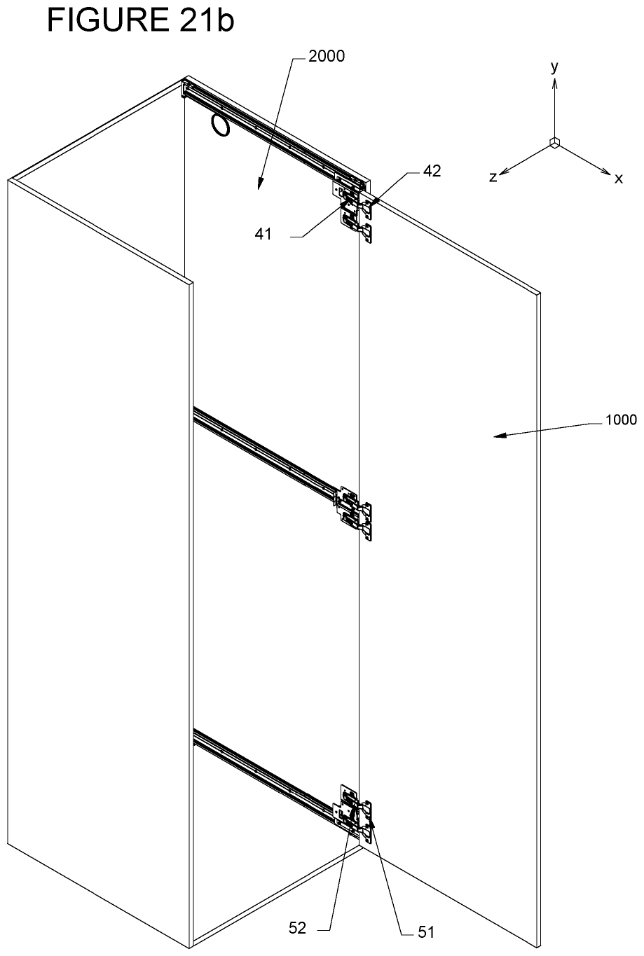

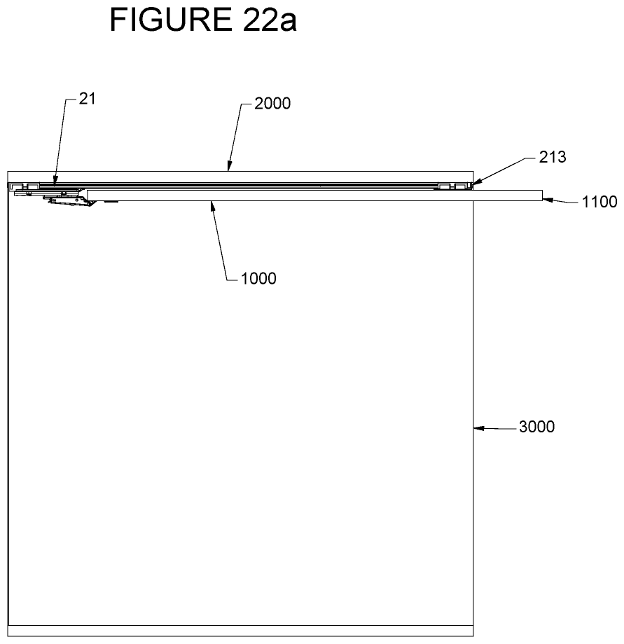

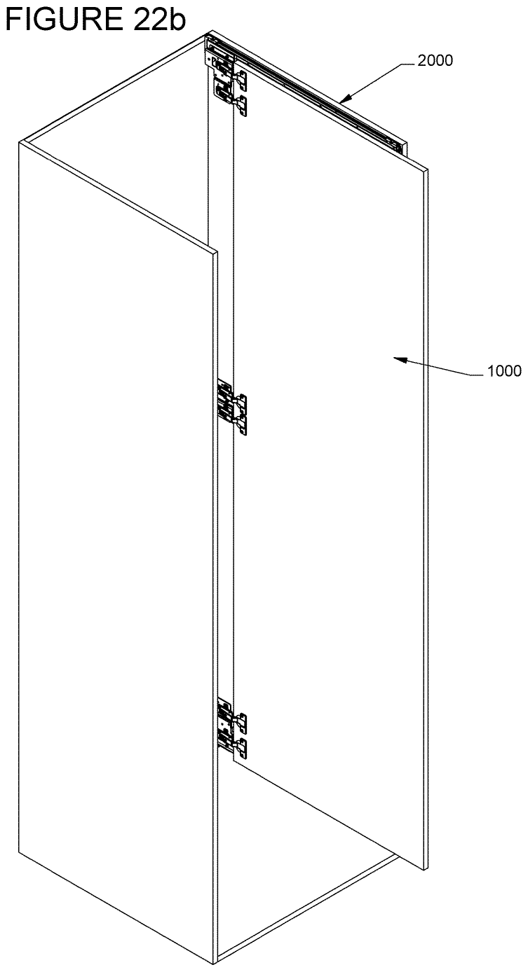

The suspension system 10 of the present invention can be used to allow a door to move between three positions: a first position as shown in FIGS. 20a and 20b, a second position as shown in FIGS. 21a and 21b, and a third position as shown in FIGS. 22a and 22b. In the first position the door 1000 is perpendicular to the wall 2000 and covers an opening defined in a second plane and the first leaf 41 of the first hinge 40 is perpendicular to the second leaf 42 and the third leaf 51 of the second hinge 50 is perpendicular to the fourth leaf 52, i.e. the first position is a “closed position” in which the door 1000 lies in a second plane parallel to the y-z plane shown in FIGS. 1 and 2. In the second position the door 1000 has been rotated and the hinges have been opened up so that the first leaf 41 and second leaf 42 are parallel to one another, and the third leaf 51 and fourth leaf 52 are parallel to one another, such that the door 1000 extends away from the opening 3000 in a direction perpendicular to the second plane and parallel to the wall 2000, i.e. the second position is an “open position” in which the door 1000 lies in a plane parallel to the x-y plane shown in FIGS. 1 and 2. In the third position the door 1000 has been translated in a direction perpendicular to the second plane and parallel to the wall 2000 until it overlies the wall 2000 and is stowed adjacent to the wall 2000, i.e. the third position is a “stowed position”. In the stowed position a front edge 1100 of the door 1000 may lie adjacent to the end of the wall 2000, and also adjacent to the first ends 213, 313 of the elongate rails 21, 31.

In the following discussion, the first end 213, 313 of the elongate rails 21, 31 is the end of the elongate rails 21, 31 closest to the door when the door is in its closed position. The second end 214, 314 of the elongate rails 21, 31 is the end of the elongate rails 21, 31 furthest from the door when the door is in its closed position.

In the closed position and the open position, the slide cassettes 22, 32 are positioned at the first end 213, 313 of their respective elongate rails 21, 31. In the stowed position, the slide cassettes 22, 32 are positioned at or close to the second end 214, 314 of their respective elongate rails 21, 31.

The elongate rails 21, 31 can be formed from many different processes. Preferably the extruded rails 21, 31 are extruded. The rails can be formed from any suitable material, and are preferably extruded aluminium rails 21, 31.

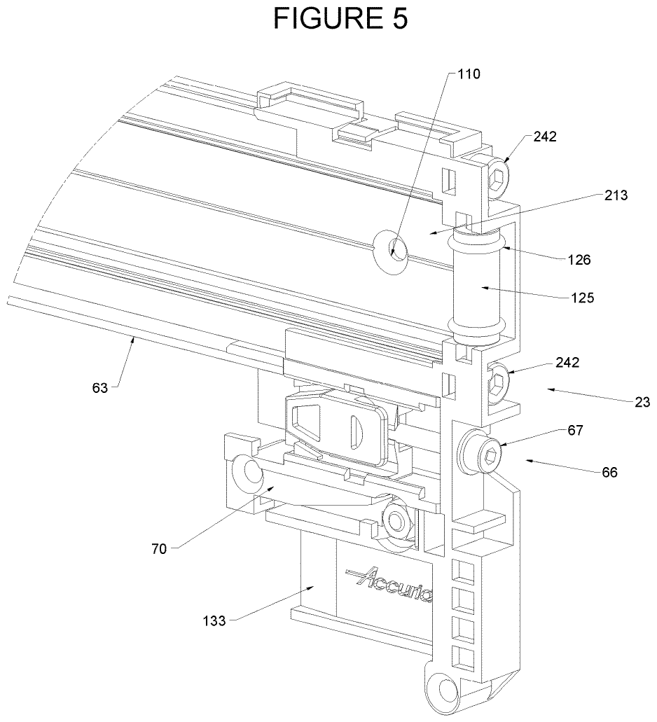

As best seen in FIG. 5, each of the first and second re-circulating ball sliding support assemblies 20, 30 further comprises a respective first end cap 23, 33 mounted in or on the first end 213, 313 of the respective elongate rail 21, 31. The end cap 33 is a mirror image of the end cap 23 as can be seen from FIG. 1.

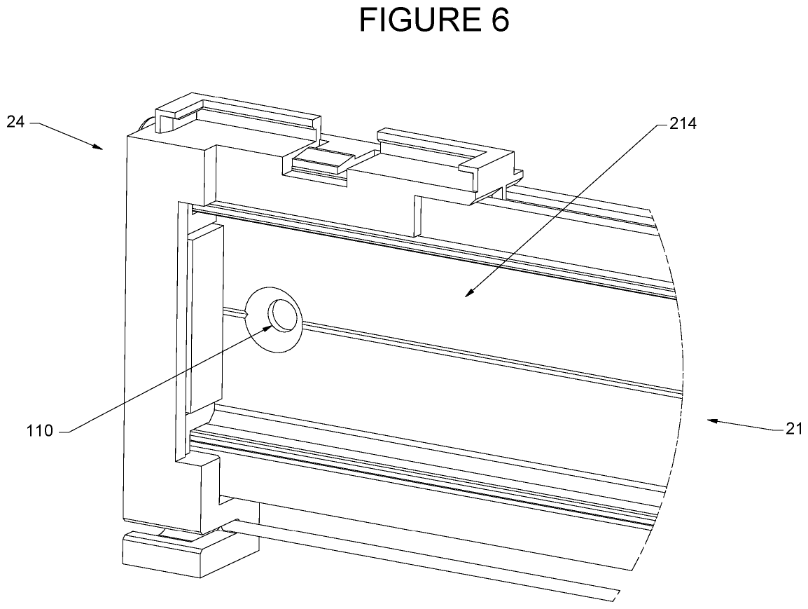

As best seen in FIG. 6, each of the first and second re-circulating ball sliding support assemblies 20, 30 further comprises a respective second end cap 24, 34 mounted in or on the second end 214, 314 of the respective elongate rail 21, 31. The end cap 34 is a mirror image of the end cap 24 as can be seen from FIG. 1.

The first and second end caps 23, 33, 24, 34 are preferably formed from a moulded plastics material.

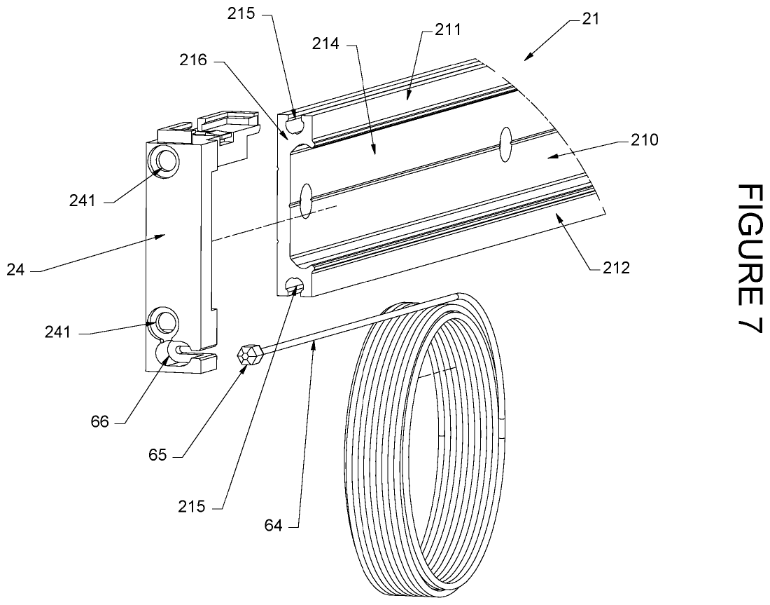

As can be seen from FIG. 7, each flange 211, 212, 311, 312 of each elongate rail 21, 31 has a fastener receiving channel 215 formed along its length for receiving a fastener (not shown) for attaching the first and/or the second end cap 23, 24, 33, 34 to the first or second end 213, 214, 313, 314 of the respective elongate rail 21, 31. Each elongate rail 21, 31 is extruded to have a constant cross-section 216 along its entire length. Consequently, each end cap 23, 24, 33, 34 can easily be attached to one of the ends 213, 313, 214, 314 of the elongate rails 21, 31, even if the elongate rails 21, 31 are cut down to reduce their length. The fastener receiving channels 215 shown in FIG. 7 are open onto an outer edge of the respective flanges 211, 212. However, alternatively, the fastener receiving channel 215 may be enclosed within the cross-section of the flange such that the cross-section of the flange has a hole therein (not shown).

Each end cap 23, 24, 33, 34 has first and second fastener receiving holes 241 formed therein which are spaced apart a distance equal to the distance between the fastener receiving channels 215 formed in the flanges 211, 212 of the respective elongate rail 21, 31. Accordingly, a pair of fasteners 242 such as screws, or rivets, can be used to connect each end cap 23, 24, 33, 34 to the respective end 213, 313, 214, 314 of the respective elongate rail 21, 31. For example, a 242 screw can be passed through each of the fastener receiving holes 241 and then screwed into the respective fastener receiving channel 215 in the elongate rail 21, 31. The size of the screw 242 can be selected so that it will self-tap into the material from which the elongate rail 21, 31 is formed. Alternatively, each end cap can include a pair of protrusions which fit into the respective fastener receiving channels. The screw 242 can then fit into the protrusion to expand the protrusion such that it frictionally engages the respective fastener receiving channel and holds the end cap in place. The protrusions can be moulded or otherwise formed as part of the end cap.

A can be seen from FIGS. 1 to 3, the first sliding support assembly 20 is positioned vertically above the second sliding support assembly 30, such that the first hinge 40 can be connected to an upper portion of the door, and the second hinge 50 can be connected to a lower portion of the door. The first and second sliding support assemblies 20, 30 comprise a mirrored pair, i.e. they may have mirror symmetry about a plane which is positioned halfway between the first sliding support assembly 20 and the second sliding support assembly 30 in the y-direction as shown in FIGS. 1 to 3.

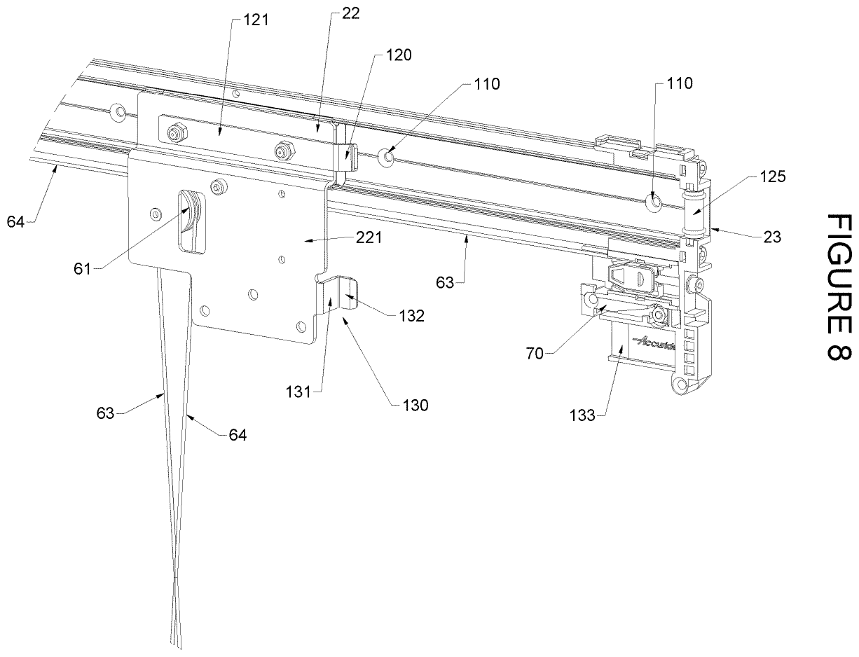

In the first example shown in FIGS. 1 to 3, the first slide cassette 22 includes a first bracket extending in a direction towards the second slide cassette 32. An enlarged view is shown in FIG. 8. Similarly, the second slide cassette 32 includes a second bracket 321 extending in a direction towards the first slide cassette 22. As noted above, the second slide cassette is a mirror image of the first slide cassette. Therefore, the second slide cassette 32 is a mirror image of the slide cassette 22 shown in FIG. 8. The first bracket 221 extends downwards from the first slide cassette 22, and the second bracket 321 extend upwards from the second slide cassette 32. In the first example, the first leaf 41 of the first hinge 40 is mounted on the first bracket 221. The third leaf 51 of the second hinge 50 is mounted on the second bracket 321. The hinges are not shown in FIG. 1 to 3 or 8. The first and second brackets 221, 321 can be formed in any appropriate way, for example they can be formed from a metal material, such as aluminium or steel or moulded from a plastics material or polymer.

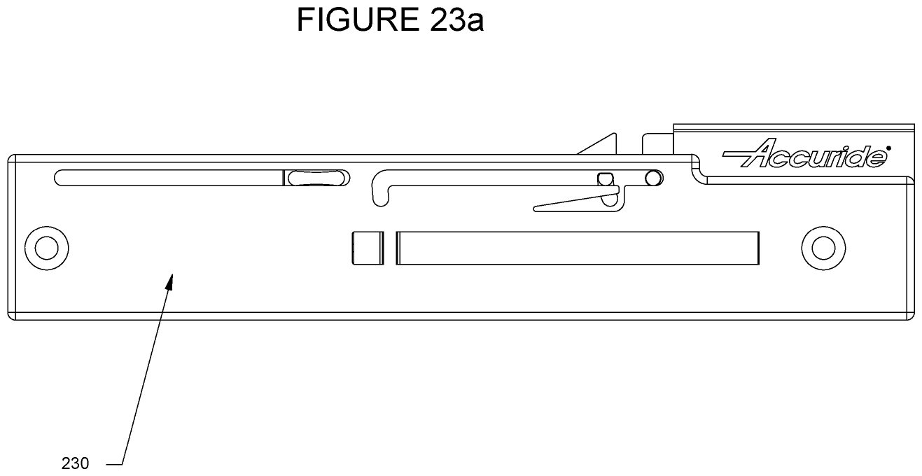

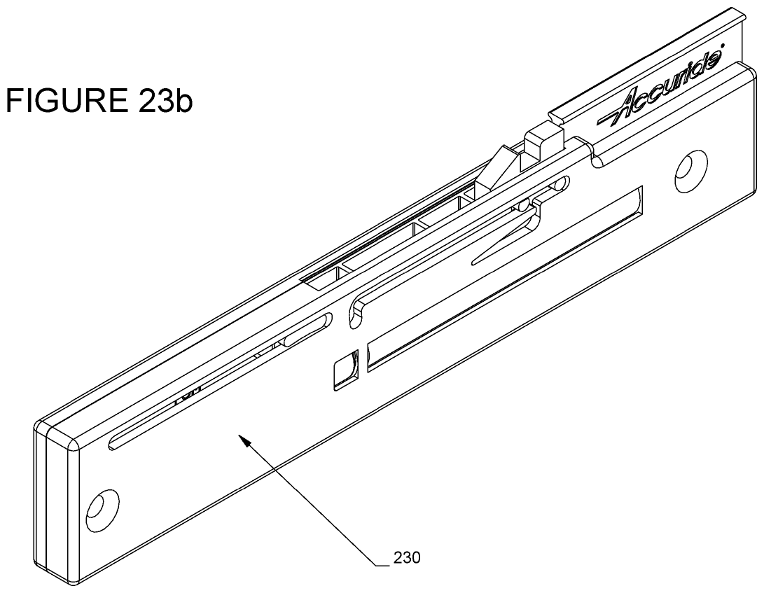

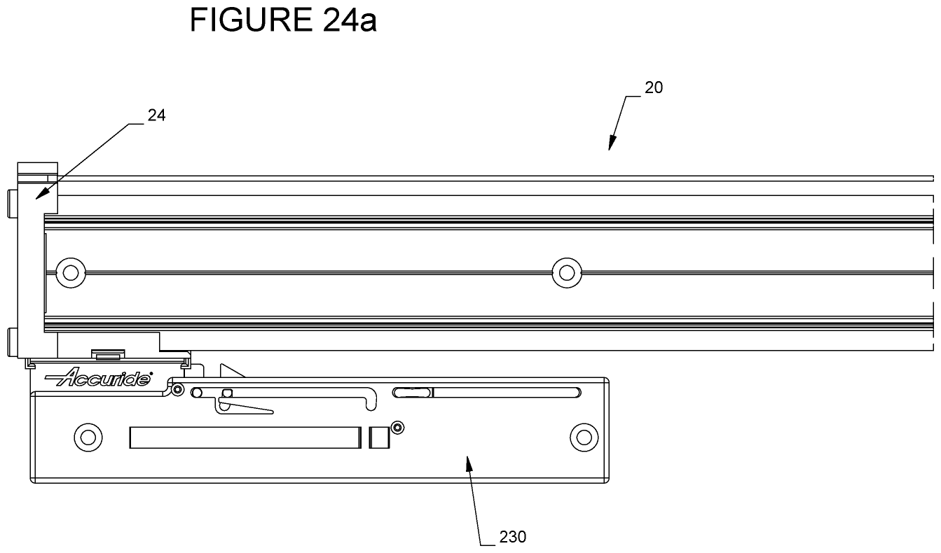

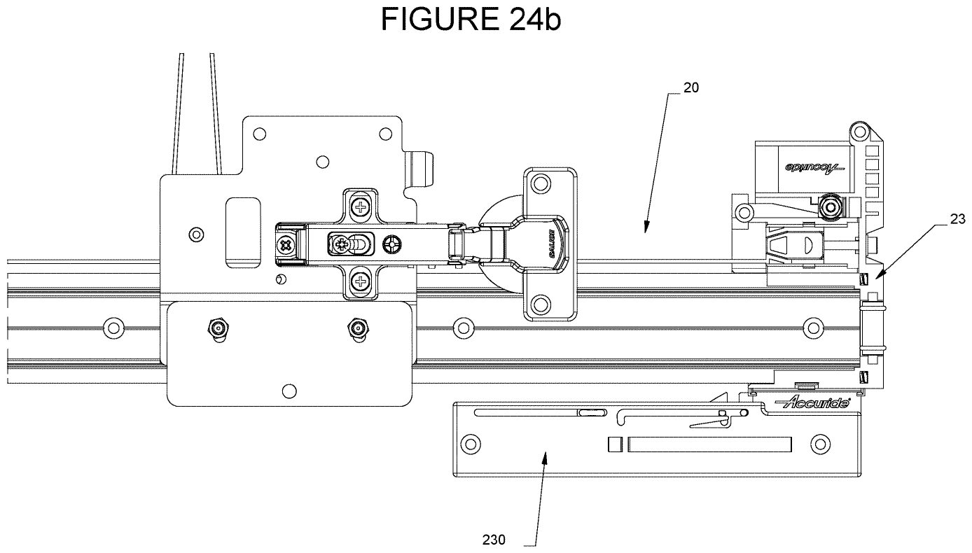

As shown in FIG. 23b, an optional self-close mechanism 230 as shown in FIGS. 23a and 23b is mounted on the or each first end cap 23, 33 to help to pull the door into its closed position. The self-close mechanism can also function as a soft-close mechanism 230 to prevent the slide cassette 21, 31 from slamming into the first end cap 23, 33 when the door moves from its stowed position to its open position. In addition, or alternatively, as shown in FIG. 24a, a soft-close mechanism 230 can also be mounted on each second end cap 24, 34 to prevent the door from banging into the back of a cabinet, or to prevent the slide cassettes 22, 32 banging into the second end caps 24, 34 when the door is moved from its open position to its stowed position. Preferably the system includes a soft-close mechanism on each second end cap 24, 34 and a self-close mechanism on each first end cap 23, 33. Such self-close or soft-close mechanisms are disclosed in U.S. Pat. No. 7,959,242 B2.

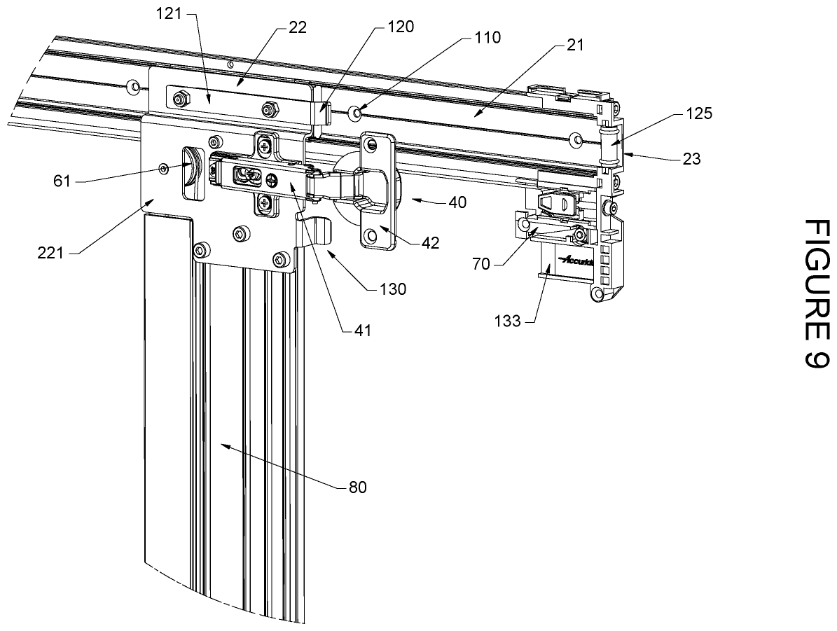

FIG. 9 shows a second example which is identical to the first example except that the first bracket 221 is connected to the second bracket 321 via a hinge carrier bar 80. All other features of the first example are included in the second example. In the second example, the first leaf 41 of the first hinge 40 and the third leaf 51 of the second hinge 50 are mounted on the first bracket 221 and the second bracket 321 respectively. However, the first leaf 41 of the first hinge and the third leaf 51 of the second hinge 50 may be mounted on the hinge carrier bar 80.

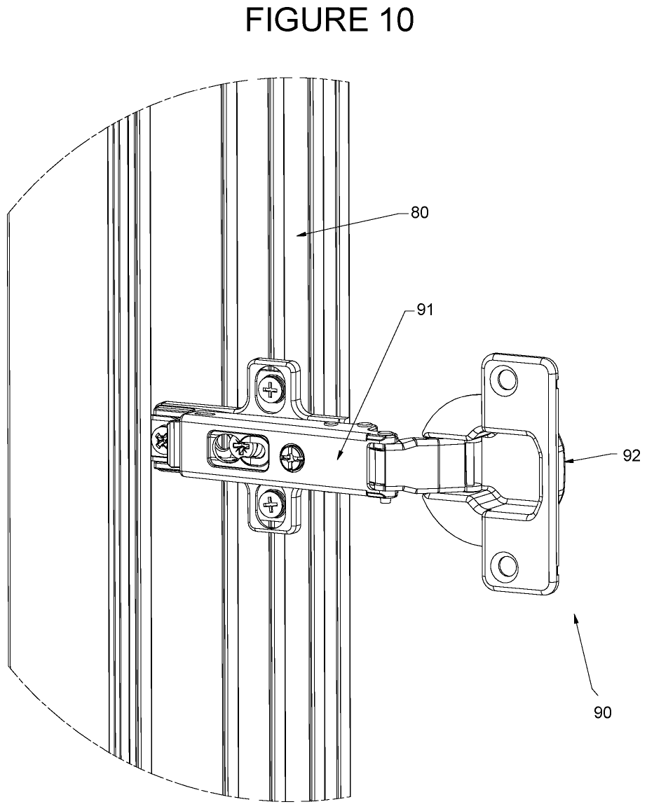

FIG. 10 shows the hinge carrier bar 80 of the second example of FIG. 9 with an optional third hinge 90 comprising fifth and sixth leaves 91, 92 connected to the hinge carrier bar 80. The fifth leaf 91 is connected to the hinge carrier bar 80 and the sixth leaf 92 is configured to be connected to the door. A plurality of such third hinges 90 can be connected to the hinge carrier bar 80 via their fifth leaves 91 to increase the number of connections between the door and the suspension system 10. Increasing the number of hinges connecting the door to the suspension system 10 prevents the door from flexing or wobbling in use. In the second example of FIGS. 9 and 10, the hinge carrier bar 80 comprises an extruded hinge carrier bar 80. The extruded hinge carrier bar 80 may comprise an aluminium extruded hinge carrier bar 80.

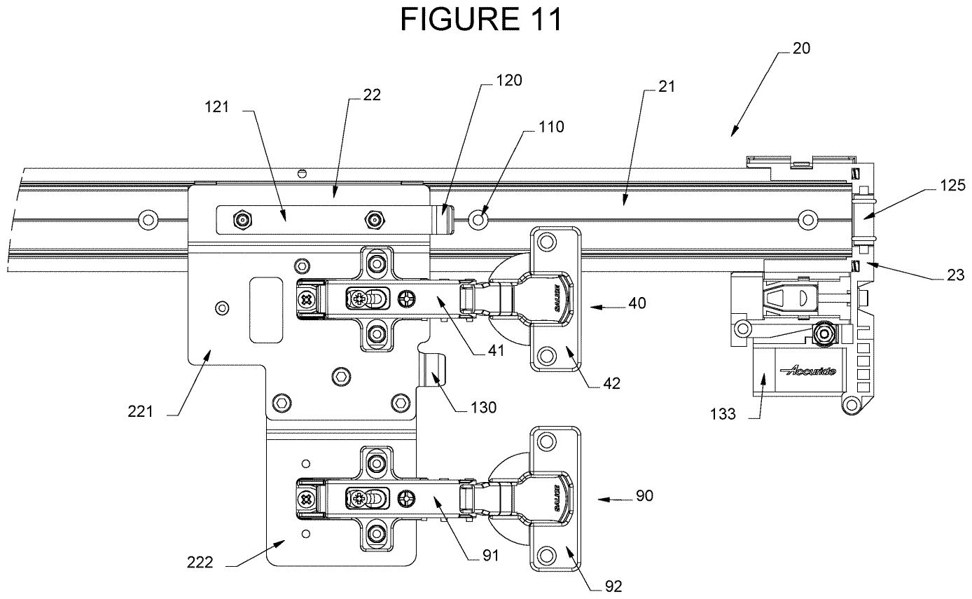

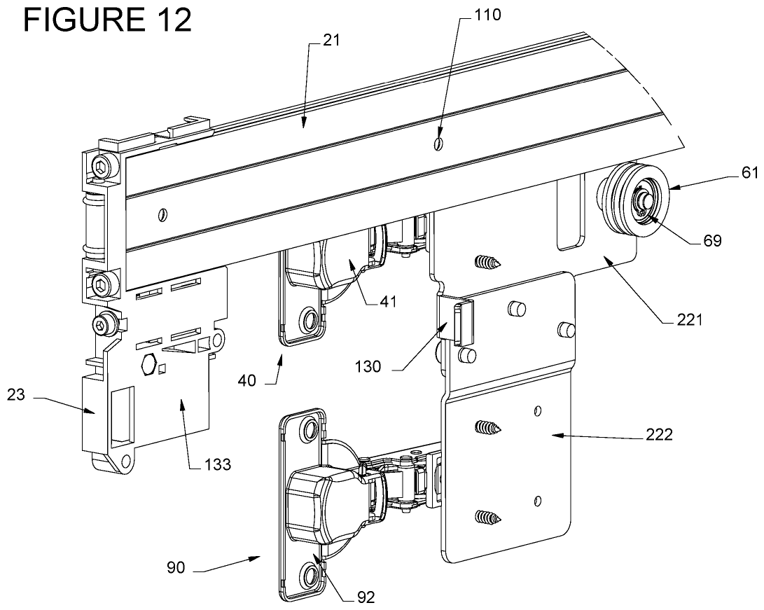

FIGS. 11 and 12 show a third example which is identical to the first example except that the first bracket 221 has an additional first hinge bracket 222 mounted thereto and extending in the direction towards the second bracket 321. The second bracket 321 also has a second hinge bracket (not shown) mounted thereto and extending in the direction towards the first bracket 221. All other features of the first example are included in the third example. The second sliding support 30 is a mirror image of the first sliding support 20. The system of the third example further comprise a third hinge 90 comprising fifth and sixth leaves 91, 92, wherein the fifth leaf 91 is connected to the first hinge bracket 222 and the sixth leaf 92 is configured to be connected to the door. Since the second sliding support 30 is a mirror image of the first sliding support 20, the system of the third example further comprises a fourth hinge comprising seventh and eighth leaves, wherein the seventh leaf is connected to the second hinge bracket and the eighth leaf is configured to be connected to the door. In this example, the number of hinges close to the top and bottom of the door is increased, without having to add a hinge carrier bar as in the second example, thus providing a cheaper way of increasing the number of hinges without the additional expense of a hinge carrier bar.

In all of the first, second and third examples, the synchronising mechanism 60 comprises a cable synchronising mechanism. In particular, the first slide cassette 22 has a first pulley wheel 61 mounted thereon, and the second slide cassette 32 has a second pulley wheel 62 mounted thereon. The first pulley wheel 61 is mounted on the first bracket 221, and the second pulley wheel 62 is mounted on the second bracket 321.

The cable synchronising mechanism 60 includes a first cable 63 and a second cable 64. A first end of the first cable 63 is connected to the first end 213 of the first elongate rail 21, and the first cable 63 runs parallel to the first elongate rail 21, around the first pulley wheel 61 and towards the second elongate rail 31, around the second pulley wheel 62, and then parallel to the second elongate rail 31. A second end of the first cable 63 is connected to the second end 314 of the second elongate rail 31. A first end of the second cable 64 is connected to the first end 313 of the second elongate rail 31, and the second cable 64 runs parallel to the second elongate rail 31, around the second pulley wheel 62 and towards the first elongate rail 21, around the first pulley wheel 61, and then parallel to the first elongate rail 21. A second end of the second cable 64 is connected to the second end 214 of the first elongate rail 21. The cables 63, 64 are connected to the respective ends 213, 313, 214, 314 of the elongate rails 21, 31 via a connection between the cable 63, 64 and the respective end cap 23, 24, 33, 34. For example, as can be seen in FIG. 7, each cable may have a nub 65 at its second end which fits into a recess 65 in the respective second end cap 24, 34. As best seen in FIG. 5, the first end of each cable 63, 64 may be connected to the respective first end cap 23, 33 via an adjustable tensioning mechanism 66, 70 including a threaded adjustment screw 67 to provide for adjustment of the synchronisation mechanism.

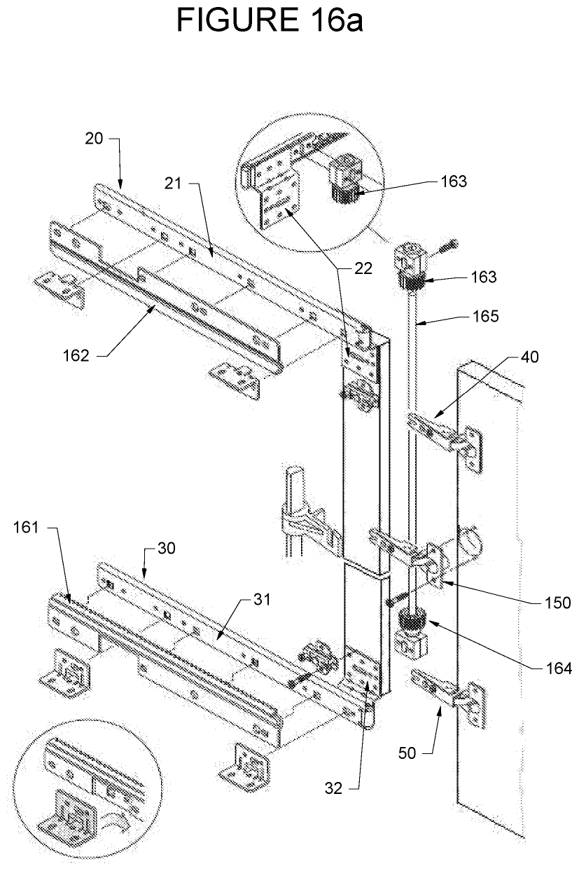

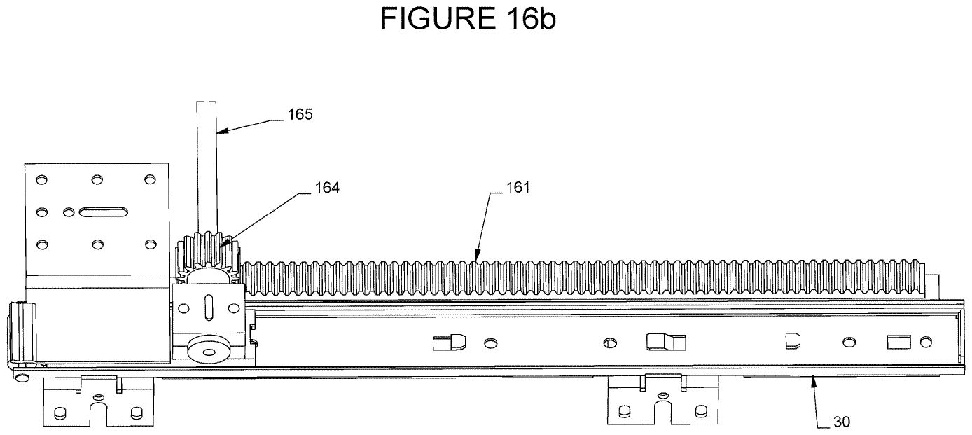

Other cable synchronising mechanisms are known and can be used with the systems of any of the examples of the present invention. Similarly, a rack and pinion synchronising mechanism may be used in place of the cable synchronising mechanism in any of the examples of the present invention. Such a rack and pinion synchronising mechanism is shown in FIGS. 16a and 16b. The rack and pinion synchronising mechanism includes first and second gear racks 161, 162, which are preferably formed from a plastics material, attached to the fixed first and second elongate rails 21, 31 of each of the two sliding support assemblies 20, 30. The rack and pinion synchronising mechanism further includes first and second pinions 163, 164, which are preferably formed from a plastics material, attached to the first and second moveable, slide cassettes, 22, 32. The two pinions 163, 164 are connected to one another via a rod 165, which is preferably formed from steel. The rod 165 preferably has a “D” shaped cross-section to prevent the pinions 163, 164 rotating relative to the rod 165 and each other. As a consequence, when one of the pinions 163, 164 rotates, the rod 165 and the other of the pinions 163, 164 also rotates. Therefore, movement of the slide cassettes 22, 32 along the elongate rails 21, 31 respectively is synchronised by the rack, pinion and rod system.

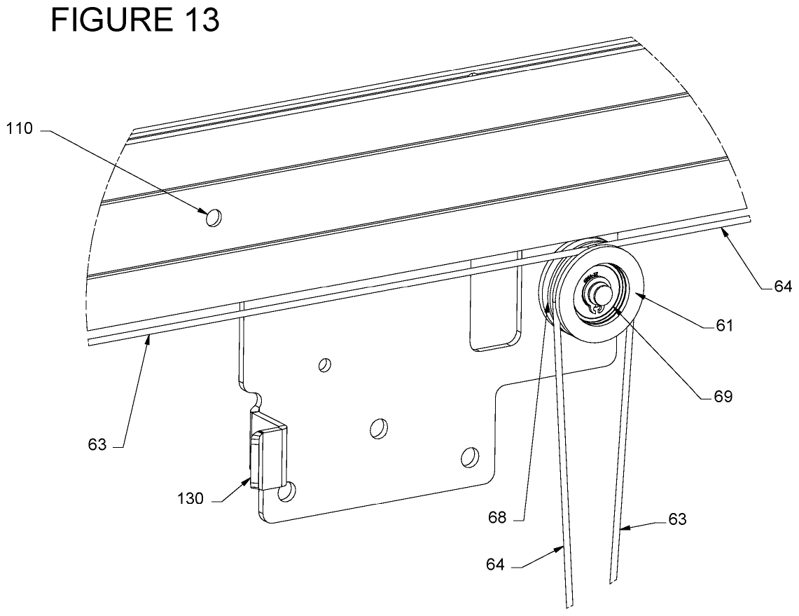

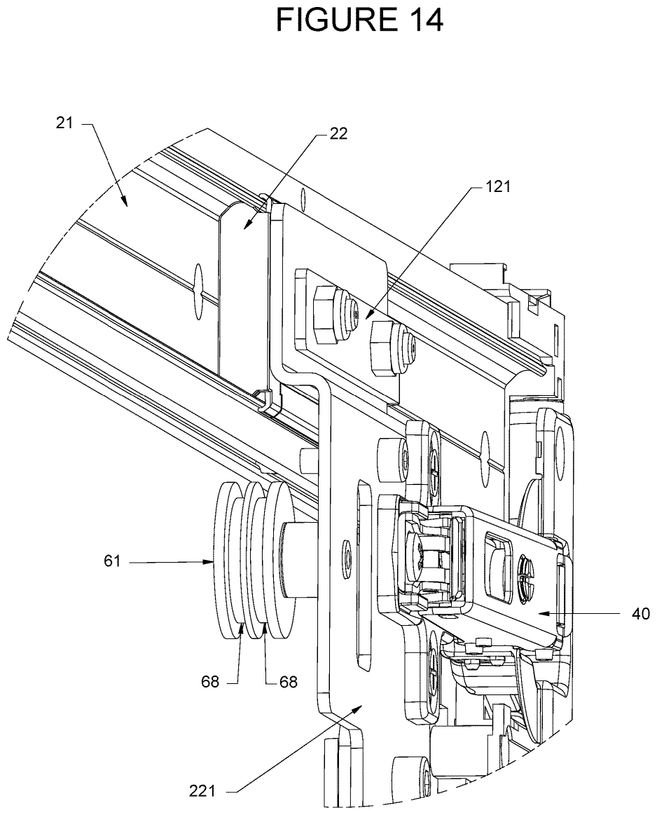

As best seen in FIG. 13, each of the first and second pulley wheels 61, 62 includes a guide surface 68 in which the first and second 63, 64 cables can run. Each of the first and second pulley wheels 61, 62 can include a pair of such guide surfaces 68, as best seen in FIG. 14, where the first cable 63 runs in a first of the guide surfaces 68 and the second cable 64 runs in a second of the guide surfaces 68. Each guide surface 68 can be moulded into the respective pulley wheel 61, 62, or formed by cutting a channel into a cylindrical surface of the respective pulley wheel 61, 62, or by forming the pulley wheel 61, 62 from a stack of different diameter discs. The cross-section of the guide surface may be semi-circular, u-shaped or v-shaped, for example.

The first and second pulley wheels 61, 62 are mounted on the respective first and second slide cassettes 22, 32 via first and second bearings 69. The first and second bearings 69 allow a higher tension to be applied to the cables 63, 64 which improves the synchronisation and ensures a smoother movement of the door and slide cassettes 22, 32 along the elongate rails 21, 31. The first and second bearings 69 also improve the durability of the synchronisation mechanism and system. The synchronising mechanism 60 functions to ensure that any movement of the first slide cassette 22 along the first elongate rail 21 is synchronised with any movement of the second slide cassette 32 along the second elongate rail 31. That is, the distance between the first end 213 of the first elongate rail 21 and the first slide cassette 22 is the same as the distance between the first end 313 of the second elongate rail 31 and the second slide cassette 32. The synchronising mechanism prevents the door from being skewed or sagging, and the slide cassettes 22, 32 from becoming jammed in their elongate rails 21, 31 when the door is slid from its open position to its stowed position.

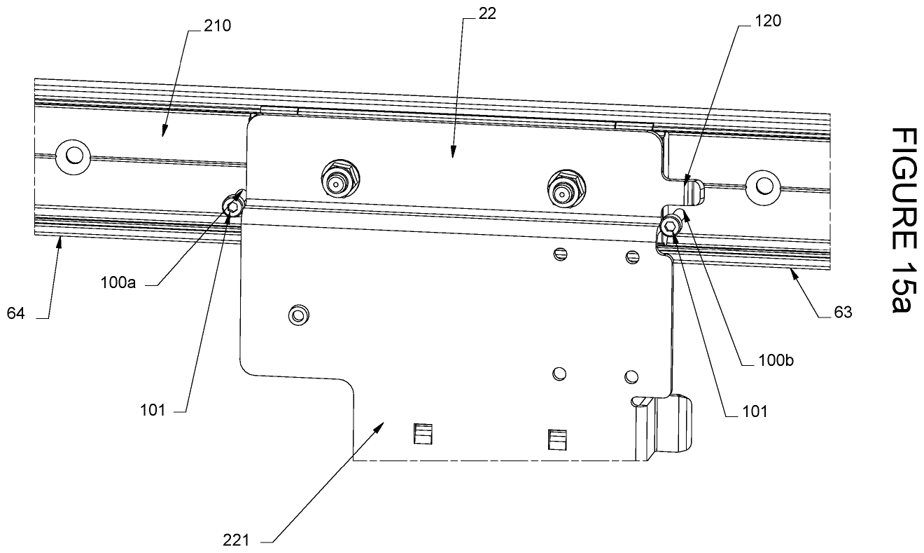

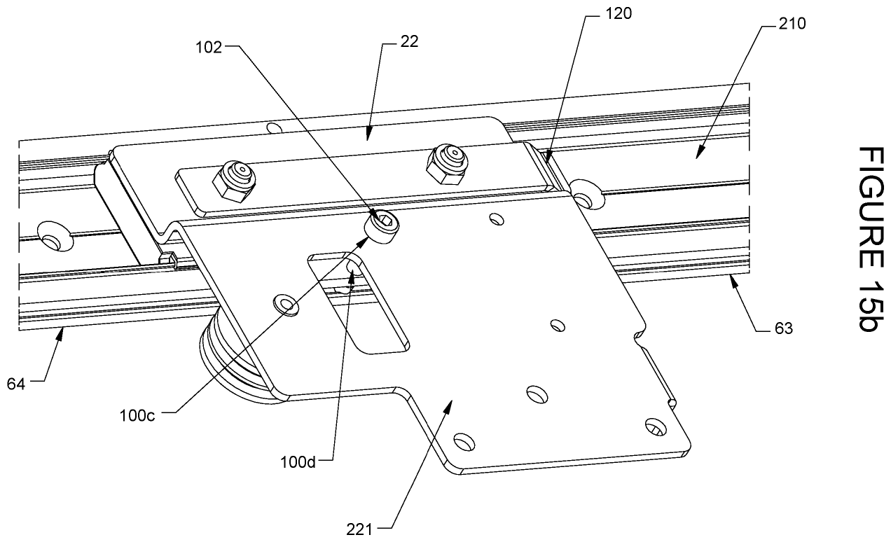

FIGS. 15a and 15b show alternative first and second mechanisms for setting the sequencing of the two sliding support assemblies 20, 30, i.e. in order to align the first slide cassette 22 and the second slide cassette 32 during initial setup of the suspension system 10. Both of the alternative first and second mechanisms comprise a means for holding the first and second cassettes in a known, aligned position within their respective elongate rail so that the synchronising cables can be fitted to the system and connected to the first and second ends of the elongate rails. For ease of installation, the system can be supplied with the slide cassettes 22, 32 fixed relative to the elongate rails 21, 31 so that the synchronisation cables can be set up without the sliding cassettes 22, 32 coming our of alignment.

In the first alternative mechanism shown in FIG. 15a, the means for holding the first and second cassettes comprises a pair of holes formed in the web 210, 310 of each elongate rail 21, 31. The pair of holes comprises a first hole 100a and a second hole 100b. The distance between the first hole 100a and the second hole 100b corresponds to a length of the slide cassette 22, 32 measured in the direction parallel to the length of the respective elongate rail 21, 31. The distance between the first hole 100a in the first elongate rail 21 and the first end 213 of the first elongate rail 21 is the same as the distance between the first hole 100a in the second elongate rail 31 and the first end 313 of the second elongate rail 31. The distance between the second hole 100b in the first elongate rail 21 and the first end 213 of the first elongate rail 21 is the same as the distance between the second hole 100b in the second elongate tail 31 and the first end 313 of the second elongate rail 31. Accordingly, during initial set up, a fastener 101 or stop can be placed in each of the first and second holes 100a, 100b to hold the first and second slide cassettes 22, 32 in a known, aligned position within their respective elongate rail 21, 31. The cables 63, 64 of the synchronising mechanism 60 can then be fitted to the system 10 and connected to the first and second ends 213, 313, 214, 314 of the elongate rails 21, 31. Once the cables 63, 64 have been fitted and connected, the fasteners 101 or stops can be removed entirely from each of the first and second holes 100a, 100b. This arrangement provides a simple and reliable way of setting the synchronisation between the two sliding support assemblies 20, 30. This mechanism is applicable to all of the described examples.

In the second alternative mechanism shown in FIG. 15b, the means for holding the first and second cassettes comprises a first hole 100c in the first slide cassette 22, a corresponding second hole (not shown) In the second slide cassette 32, a third hole 100d in the first web 210 of the first elongate rail 21, and a fourth hole (not shown) in the second web 310 of the second elongate rail 31. The distance between the third hole 100d and the first end 213 of the first elongate rail 21 is the same as the distance between the fourth hole and the first end 313 of the second elongate rail 31. The first hole 100c in the first slide cassette 22 is positioned a first distance from a first end of the first slide cassette 22. The second hole in the second slide cassette 32 is positioned the same first distance from a first end of the second slide cassette 32. Accordingly, during initial set up, a first fastener or stop 102 can be placed in the first and third holes 100c, 100d, and a second fastener or stop (not shown) can be placed in the second and fourth holes to hold the first and second slide cassettes 22, 32 in a known, aligned position within their respective elongate rail 21, 31. The cables 63, 64 of the synchronising mechanism 60 can then be fitted to the system 10 and connected to the first and second ends 213, 313, 214, 314 of the elongate rails 21, 31. Once the cables 63, 64 have been fitted and connected, the fasteners or stops 102 can be removed from each of the third hole 100d and fourth hole. The fasteners or stops 102 can then be left in place in the first hole 100c and second hole, or removed from the cassettes 22, 32 entirely. This arrangement provides a simple and reliable way of setting the synchronisation between the two sliding support assemblies 20, 30 and is applicable to all of the described examples. With this alternative mechanism by having the third hole 100d in the elongate rail, the elongate rail becomes unhanded so that it can also be used with symmetrically opposite-handed brackets.

In all of the examples, the elongate rails 21, 31 also include mounting holes 110. Each mounting hole 110 is positioned for receiving a fastener (not shown) such as a screw for connecting the elongate rail 21, 31 to the wall.

In all of the examples, the first and second slide cassettes 22, 32 also each include a detent mechanism which can interact with a receiving mechanism on the first end cap 23, 33 in order to resist motion of the first and second slide cassettes 22, 32 relative to the respective first end cap 23, 33. In the pictured examples, the detent mechanism comprises a tab 120 extending from the respective slide cassette 22, 32 in a direction parallel to the length of the elongate rail 21, 31. The receiving mechanism comprises a roller 125 mounted on the first end cap 23, 33. The tab 120 is shaped to catch around the roller 125 in order to increase the force required to start motion of the first and second slide cassettes 22, 32 along their respective elongate rail 21, 31. In particular, as best seen in FIG. 8, the tab 120 has a curved portion shaped to curve around the outer cylindrical surface of the roller 125. The tab 120 of the detent mechanism may extend from a bracket mounted on the slide cassette 22, 32, such as the first and second bracket 221, 321 mentioned above, as in the configuration shown in FIG. 15. Alternatively, the detent mechanism may comprise a separate detent bar 121 connected to the slide cassette 22, 32 and/or connected to the first or second bracket 221, 321. The tab 120 and/or detent bar 121 may be formed from a metal or plastics material and the roller 125 may be formed from a metal or plastics material.

In all of the examples, a spacer roller may be mounted on the first end cap 23, 33 whether or not the first and second slide cassettes 22, 32 include a detent mechanism. If a detent mechanism is present, the spacer roller may comprise the same roller as the roller 125 of the receiving mechanism for the detent mechanism. Alternatively, the spacer roller may comprise an additional roller to the roller 125 of the receiving mechanism for the detent mechanism. In all of the examples shown in the figures, the spacer roller and the roller of the receiving mechanism for the detent mechanism are the same roller 125. The spacer roller 125 extends away from the elongate rail 21, 31 in a direction perpendicular to the web 210, 310 of the elongate rail 21, 31. The spacer roller 125 extends in that direction further than other parts of the first end cap 23, 33 and further than the flanges 211, 212, 311, 312 of the respective elongate rail 21, 31, so that, as the door is moved from its open position to its stowed position, the front surface of the door is held away from the first end cap 23, 33 and the elongate rail 21, 31 and prevented from being scratched. The spacer roller 125 may be formed from a plastics material and, as best seen in FIG. 6, may have rubberised o-rings 126 mounted around the cylindrical surface of the spacer roller 125 to absorb any vibrations and prevent marking of the front surface of the door with prolonged use. Alternatively, instead of having rubberised o-rings 126, the spacer roller 125 may be moulded or otherwise formed with one or more ridges to absorb any vibrations and prevent marking of the front surface of the door. The spacer 125 roller may be moulded or otherwise formed from a single material or from two different materials such that the ridges may be formed from the same or a different material from the body of the spacer roller 125.

When the door is moved from the open position to the closed position, the weight of the door acts to pull the re-circulating ball slide cassette 22, 32 out of the channel section of the elongate rail, in a direction perpendicular to the web 210, 310 of its elongate rail 21, 31 (in the z-direction as shown in FIG. 1). This is particularly the case with the upper sliding support assembly 20 connected to the upper end of the door. In order to prevent the weight of the door pulling the sliding support assemblies 20, 30 apart, and thus to allow the suspension system 10 to be used with much larger and heavier doors, in all of the described examples, the first and second sliding support assemblies 20, 30 include a catch mechanism which prevents movement of the slide cassette 22, 32 out of the channel section of the elongate rail 21, 31 in a direction perpendicular to the web 210, 310 of the elongate rail 21, 31. In particular, the catch mechanism includes an L-shaped catch portion 130 formed on the first and second brackets 221, 321. As best seen in FIG. 8, the L-shaped catch portion 130 has two legs 131, 132, wherein a first leg 131 extends from the respective bracket 221, 321 in a direction perpendicular to the web 210, 310 of the elongate rail 21, 31 and the second leg 132 is connected to the first leg 131 and extends in a direction parallel to the web 210, 310 of the elongate rail 21, 31. The catch mechanism further includes a wall 133 formed in or by the first end cap 23, 33, which is configured and positioned to prevent the second leg 132 of the catch portion 130 moving in a direction perpendicular to the web 210, 310 of the elongate rail 21, 31. The wall 133 extends in a direction parallel to the web 210, 310 of the elongate rail 21, 31. When the second leg 132 is positioned behind the wall, i.e. in the-z direction as shown in FIG. 1, the wall 133 prevents the catch portion 130 from moving in a direction perpendicular to the web 210, 310 of the elongate rail 21, 31. Consequently, the catch mechanism prevents the weight of the door pulling the slide cassette 22, 32 out of the channel section of the elongate rail and away from the web 210, 310 of the elongate rail 21, 31.

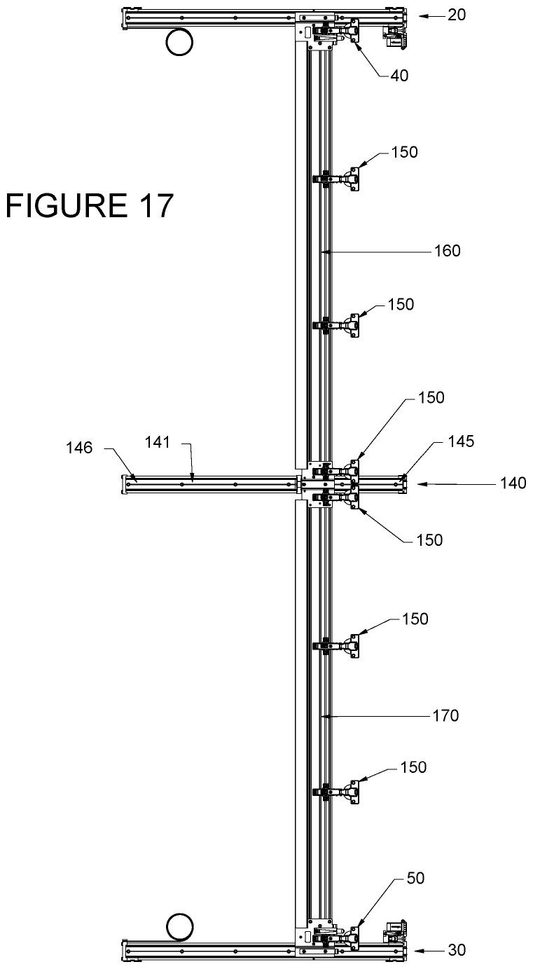

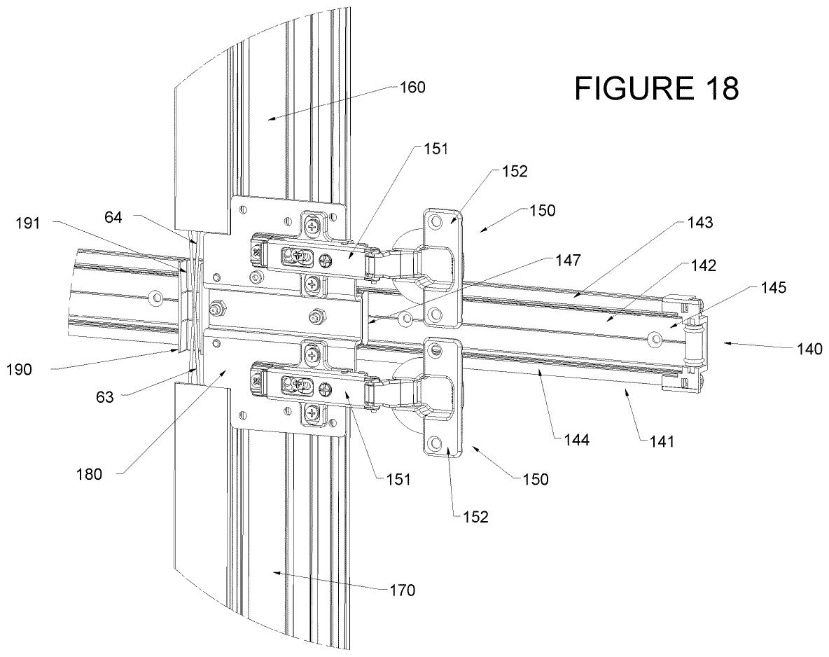

FIGS. 17 and 18 show a fourth example of a suspension system according to the present invention. In the fourth example, the first and second re-circulating ball sliding support assemblies 20, 30 and other common features, are identical to those in the first example. However, the system 10 further includes a third re-circulating ball sliding support assembly 140, comprising: a third elongate rail 141 of channel section defining a third web 142 and fifth and sixth flanges 143, 144. The third elongate rail 141 has a first end 145 and a second end 146. A third slide cassette 147 is positioned between the fifth and sixth flanges 143, 144 such that the third slide cassette 147 and the fifth and sixth flanges 143, 144 define a fifth endless track and a sixth endless track in the same way as shown in FIG. 4. A third plurality of bearing balls 223 is positioned within the fifth and sixth endless tracks as in FIG. 4. Alternatively, the body of the third slide cassette may have a cross-section that is configured such that the third slide cassette and the fifth and sixth flanges define a single endless track in a figure of eight configuration. The third elongate rail 141 is configured to be mounted on the wall between the first elongate rail 21 and the second elongate rail 31, such that the first, second and third re-circulating ball sliding support 20, 30, 140 assemblies are spaced apart and parallel to one another, wherein the first ends 213, 313, 145 of the first, second and third elongate rails 21, 31, 141 are aligned with one another, and the second ends 214, 314, 146 of the first, second and third elongate rails 21, 31, 141 are aligned with one another, though it is not essential for the second ends 214, 314, 146 of the first, second and third elongate rails 21, 31, 141 to be aligned with one another.

The example of FIGS. 17 and 18 further includes a pair of third hinges 150, each comprising a fifth leaf 151 and a sixth leaf 152, wherein the fifth leaves 151 are connected to the third slide cassette 147 and the sixth leaves 152 are configured to be connected to the door.

The addition of the third sliding assembly 140 provides for increased loading capability so that the suspension system 10 can be used with larger and heavier doors.

In the example shown in FIGS. 17 and 18, the third slide cassette 147 is connected to the first slide cassette 22 via a first bar 160. The first bar 160 comprises a hinge carrier bar onto which additional third hinges 150 can be mounted. The third slide cassette 147 is also connected to the second slide cassette 32 via a second bar 170. The second bar 170 also comprises a hinge carrier bar onto which additional third hinges 150 can be mounted.

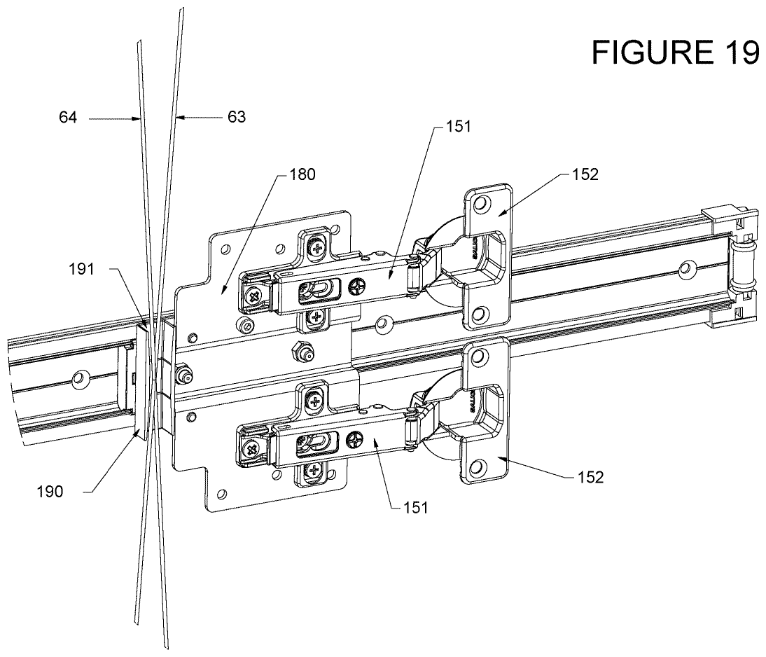

FIG. 19 shows a portion of a fifth example of the present invention. The fifth example is identical to the fourth example except that there is no first or second bar 160, 170 connecting the third slide cassette 147 to the first and second slide cassettes 22, 32.

In both the fourth and fifth examples, the third slide cassette 147 includes a third bracket 180 extending from both sides of the third slide cassette 147 towards both the first slide cassette 22 and the second slide cassette 32. Accordingly, the third bracket 180 extends upwards towards the first slide cassette 22 and downwards towards the second slide cassette 32. The fifth leaf 151 of a third hinge 150 is mounted on the part of the third bracket 180 that extends towards the first slide cassette 22. The fifth leaf 151 of another third hinge 150 is mounted on the part of the third bracket 180 that extends towards the second slide cassette 32.

Prior to the present invention, it had not been possible to add a third, central sliding assembly to a suspension system for a pocket door because the third slide mechanism would get in the way of the synchronising mechanism 60. The fourth and fifth examples of the present invention address this problem.

In the fourth and fifth examples, a guide member 190 is mounted on the third slide cassette 147. The guide member 190 defines a channel 191 through which the cables 63, 64 of the synchronising mechanism 60 can pass. The guide member 190 may comprise a channel section 190 moulded or otherwise formed from a plastics or metal material. The guide member 190 may be formed as part of the third bracket 180. In particular, the guide member 190 may comprise a metal or plastics channel formed as part of the third bracket 180.

The first and second pulley wheels 61, 62 are mounted on the first and second slide cassettes 22, 32 in such a way that the guide surfaces 68 of the pulley wheels 61, 62 are further away from the webs 210, 310, 142 of the elongate rails 21, 31, 141 than the flanges 211, 212, 311, 312, 143, 144 of the elongate rails 21, 31, 141 are from the webs 210, 310, 142 of the elongate rails 21, 31, 141 in the direction perpendicular to the webs 210, 310, 142 of the elongate rails 21, 31, 141, i.e. in the z direction shown in FIG. 1. As a consequence, the cables 63, 64 can pass through the guide member 190 on the third slide cassette 147 without interfering with the elongate rail 141 of the third recirculating-ball sliding support assembly 140. The guide member 190 prevents the cables 63, 64 from rubbing on the third elongate rail 141 or third slide cassette 147 during use. However, there is no functional connection between the cables 63, 64 of the synchronisation mechanism 60 and the third sliding support assembly 140.

The present invention has been described above in exemplary form with reference to the accompanying drawings which represent a plurality of embodiments and example of the invention. It will be understood that features of the different embodiments and examples can be combined, and that such combinations of the disclosed embodiments and examples also fall within the scope of the invention as defined by the following claims.

1. (canceled)

2. (canceled)

3. (canceled)

4. (canceled)

5. A suspension system for a door, the suspension system comprising:
a first ball sliding support assembly, comprising:
a first elongate rail of channel section defining a first web and first and second flanges, the first elongate rail having a first end and a second end;
a first plurality of bearing balls positioned within first channels defined by the first and second flanges; and
a first slide cassette positioned between the first and second flanges such that the first slide cassette is retained between the first and second flanges and can slide on the first plurality of bearing balls within the first channels;
a second ball sliding support assembly, comprising:
a second elongate rail of channel section defining a second web and third and fourth flanges, the second elongate rail having a first end and a second end;
a second plurality of bearing balls positioned within second channels defined by the third and fourth flanges;
a second slide cassette positioned between the third and fourth flanges such that the second slide cassette is retained between the third and fourth flanges and can slide on the second plurality of bearing balls within the second channels;
a first hinge comprising first and second leaves, wherein the first leaf is connected to the first slide cassette and the second leaf is configured to be connected to the door;
a second hinge comprising third and fourth leaves, wherein the third leaf is connected to the second slide cassette and the fourth leaf is configured to be connected to the door;
a synchronising mechanism configured to maintain the positions of the first and second slide cassettes within the respective first and second elongate rails such that a distance between the first slide cassette and the first end of the first elongate rail is always the same as a distance between the second slide cassette and the first end of the second elongate rail; and
a means for holding the first and second cassettes in a known, aligned position within their respective elongate rail;
wherein the first and second elongate rails are configured to be mounted on a supporting wall defining a first plane, such that said first and second ball sliding support assemblies are spaced apart and parallel to one another, wherein the first ends of the first and second elongate rails are aligned with one another;
wherein the means for holding the first and second cassettes comprises a first hole in the first slide cassette, a corresponding second hole in the second slide cassette, a third hole in the first web of the first elongate rail, and a fourth hole in the second web of the second elongate rail;
wherein the distance between the third hole and the first end of the first elongate rail is the same as the distance between the fourth hole and the first end of the second elongate rail;
wherein the first hole in the first slide cassette is positioned a first distance from a first end of the first slide cassette; and
wherein the second hole in the second slide cassette is positioned the same first distance from a first end of the second slide cassette.

6. (canceled)

7. The suspension system of claim 5, wherein each of the ball sliding support assemblies further comprises a respective first end cap mounted in or on the first end of the respective elongate rail.

8. The suspension system of claim 7, wherein each of the ball sliding support assemblies further comprises a respective second end cap mounted in or on the second end of the respective elongate rail.

9. The suspension system of claim 7, and further comprising a self-close mechanism mounted on the or each first end cap.

10. The suspension system of claim 8, and further comprising a soft-close mechanism mounted on the or each second end cap.

11. The suspension system of claim 7, wherein each flange of each elongate rail has a fastener receiving channel formed along its length for receiving a fastener for attaching the respective end cap to the respective end of the respective elongate rail.

12. The suspension system of claim 11, wherein each fastener receiving channel opens onto an outer edge of the respective flange.

13. The suspension system of claim 11, wherein each end cap has first and second fastener receiving holes formed therein which are spaced apart a distance equal to a distance between the fastener receiving channels formed in the flanges of the respective elongate rail.

14. The suspension system of claim 5, wherein the first slide cassette includes a first bracket extending in a direction towards the second slide cassette and the second slide cassette includes a second bracket extending in a direction towards the first slide cassette.

15. (canceled)

16. (canceled)

17. (canceled)

18. (canceled)

19. The suspension system of claim 14, wherein the first bracket has a first hinge bracket mounted thereto that extends in a direction towards the second bracket, and the second bracket has a second hinge bracket mounted thereto that extends in a direction towards the first bracket.

20. (canceled)

21. The suspension system of claim 5, wherein the synchronising mechanism comprises a cable synchronising mechanism.

22. (canceled)

23. (canceled)

24. (canceled)

25. (canceled)

26. (canceled)

27. (canceled)

28. (canceled)

29. The suspension system of claim 7, wherein each of the slide cassettes includes a detent mechanism, and each of the first end caps includes a receiving mechanism, wherein each detent mechanism is configured to interact with the respective receiving mechanism in order to resist motion of the respective slide cassette relative to the respective first end cap.

30. (canceled)

31. (canceled)

32. (canceled)

33. (canceled)

34. (canceled)

35. The suspension system of claim 5, and further comprising:
a third re-circulating ball sliding support assembly, comprising:
a third elongate rail of channel section defining a third web and fifth and sixth flanges, the third elongate rail having a first end and a second end;
a third slide cassette positioned between the fifth and sixth flanges such that the third slide cassette and the fifth and sixth flanges define at least one third endless track; and
a third plurality of bearing balls positioned within the at least one third endless track;
wherein:
the third elongate rail is configured to be mounted on the wall between the first elongate rail and the second elongate rail, such that the first, second and third re-circulating ball sliding support assemblies are spaced apart and parallel to one another, wherein the first ends of the first, second and third elongate rails are aligned with one another; and
at least one third hinge comprising fifth and sixth leaves, wherein the fifth leaf is connected to the third slide cassette and the sixth leaf is configured to be connected to the door.

36. (canceled)

37. (canceled)

38. (canceled)

39. (canceled)

40. (canceled)

41. The suspension system of claim 5, wherein each sliding support assembly includes a catch mechanism which prevents movement of the respective slide cassette out of the channel section of the respective elongate rail in a direction perpendicular to the web of the elongate rail.

42. The suspension system of claim 41, wherein the catch mechanism includes:
an L-shaped catch portion having a first leg and a second leg, wherein the first leg extends from the slide cassette in a direction perpendicular to the web of the elongate rail, and the second leg is connected to the first leg and extends in a direction parallel to the web of the elongate rail; and
a wall formed in or by the first end cap, wherein the wall is configured and positioned such that the second leg can be positioned behind the wall in a direction perpendicular to the web of the elongate rail to prevent the second leg of the catch portion moving in the direction perpendicular to the web of the elongate rail, wherein the wall extends in a direction parallel to the web of the elongate rail.

43. (canceled)

44. (canceled)

45. (canceled)

46. (canceled)

47. (canceled)
